(19) United States
(12) Patent Application Publication
(10) Pub. No.: US 2013/0054296 A1
(43) Pub. Date: Feb. 28, 2013

(54) STRATEGIC DEAL ESTIMATION TOOL

(71) Applicants: Pramod Gajakosh, Plano, TX (US); James Christa, Plano, TX (US); Shrikrupa Parnaik, Pune (IN)

(72) Inventors: Pramod Gajakosh, Plano, TX (US); James Christa, Plano, TX (US); Shrikrupa Parnaik, Pune (IN)

(73) Assignee: Infosys Limited, Bangalore (IN)

(21) Appl. No.: 13/246,626

(22) Filed: Sep. 27, 2011

(30) Foreign Application Priority Data
Aug. 23, 2011 (IN) 2849/CHE/2011

(51) Int. Cl. G06Q 10/06

(52) U.S. Cl. 705/7.22; 705/7.11

(57) ABSTRACT

Various technologies related to estimating costs associated with proposed information technology services solutions using global sourcing are described. Consistent and accurate estimates can be achieved by using a tool having features specific to the estimating process. The tool can construct a global sourcing business case illustrating savings if the proposed solution were to be adopted. A wide variety of features related to solution parameters, costs, competitor analysis, transition billing, blended rates, business cases, and cumulative savings graphs can be supported. Superior, credible proposals can be generated that address the practical and financial demands of clients.

### BACKGROUND

In order to compete in the global marketplace, an information technology services provider must be able to generate credible proposals. Such proposals can set forth the expected savings to a prospective or current customer as a way of persuading the customer to close the deal. Significant errors or oversights can be costly and result in loss of credibility.

The ability to estimate costs and savings in a reliable manner typically requires years of experience, and can be particularly challenging for large proposals with total costs in the tens of millions of U.S. dollars. In addition, customers may require that the estimation process be completed in a very short time frame. If a services provider attempts to grow its business rapidly, it may become impossible to find sufficient experts who can assemble proper estimates. Without the proper expertise, proposals may become inconsistent and inaccurate.

Although various approaches have been taken to address such difficulties, there is still a need to address the complexities of assembling accurate and credible proposals in a timely manner.

### SUMMARY

A variety of techniques can be used for developing information technology services proposals. A tool can estimate various aspects of a proposed solution and assist in the proposal process.

Considerable efficiency and accuracy improvements in the proposal preparation process can be realized.

A business case can set forth projected savings if the proposed solution were to be adopted. Due to the features described herein, the business case can be more accurate and flexible in a variety of client situations.

As described herein, a variety of other features and advantages can be incorporated into the technologies as desired.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary system implementing the strategic deal estimation technologies described herein.

FIG. 2 is a flowchart of an exemplary method of implementing the strategic deal estimation technologies described herein.

FIG. 3 is a block diagram of an exemplary system calculating current solution spend based on characteristics of a current solution.

FIG. 4 is a flowchart of an exemplary method of calculating current solution spend based on characteristics of a current solution.

FIG. 5 is a block diagram of an exemplary system calculating proposed solution spend based on characteristics of a proposed solution.

FIG. 6 is a flowchart of an exemplary method of calculating proposed solution spend based on characteristics of a proposed solution.

FIG. 7 is a block diagram of an exemplary system supporting default solution parameters based on technology process outsourcing service type.

FIG. 8 is a flowchart of an exemplary method of selecting default solution parameters based on technology process outsourcing service type.

FIG. 9 is a block diagram of an exemplary system allocating client costs.

FIG. 10 is a flowchart of an exemplary method of allocating client costs.

FIG. 11 is a block diagram of an exemplary system designating provider costs according to whether they are billed.

FIG. 12 is a screen shot of an exemplary user interface for designating provider costs according to whether they are billed.

FIG. 13 is a flowchart of an exemplary method of designating provider costs according to whether they are billed.

FIG. 14 is a block diagram of an exemplary system comparing a provider's bid with bids of competitors, taking incumbency into account.

FIG. 15 is a screen shot of an exemplary user interface for comparing a provider's bid with bids of competitors, taking incumbency into account.

FIG. 16 is a flowchart of an exemplary method of comparing a provider's bid with bids of competitors, taking incumbency into account.

FIG. 17 is a block diagram of an exemplary system adjusting a solution based on a selected transition scenario.

FIG. 18 is a screen shot of an exemplary user interface for adjusting a solution based on a selected transition scenario.

FIG. 19 is a flowchart of an exemplary method of adjusting a solution based on a selected transition scenario.

FIG. 20 is a block diagram of an exemplary system determining solution price details.

FIG. 21 is a flowchart of an exemplary method of determining solution price details.

FIG. 22 is a block diagram of an exemplary system determining a business case.

FIG. 23 is a flowchart of an exemplary method of determining a business case.

FIG. 24 is a block diagram of an exemplary system displaying a cumulative savings graph.

FIG. 25 is a screen shot of an exemplary user interface for displaying a cumulative savings graph.

FIG. 26 is a flowchart of an exemplary method of displaying a cumulative savings graph.

FIG. 27 is a block diagram of an exemplary page arrangement.

FIG. 28 is a flowchart of an exemplary process for using a strategic deal estimation tool.

FIG. 29 is a screen shot of an exemplary user interface for a master page.

FIG. 30 is screen shot of another exemplary user interface for a master page.

FIG. 31 is screen shot of another exemplary user interface for a master page.

FIG. 32 is screen shot of an exemplary user interface for a solution parameters page.

FIG. 33 is a block diagram of an exemplary computing environment suitable for implementing any of the technologies described herein.

### DETAILED DESCRIPTION

### Example 1

### Exemplary Overview

The technologies described herein can be used for a variety of proposal generation and estimation scenarios. Adoption of the technologies can provide an efficient technique for generating and evaluating proposed solutions in a variety of pursuits.

The technologies are targeted to solution architects, who will appreciate the design approach. However, the delivery team that is to execute the proposed solution can also benefit from the tool because it can provide outputs that are readily intelligible and transparent to them. And, clients greatly benefit from the technologies because they enjoy accurate and credible proposals targeted to their specific business organization.

### Example 2

### Exemplary System Employing a Combination of the Technologies

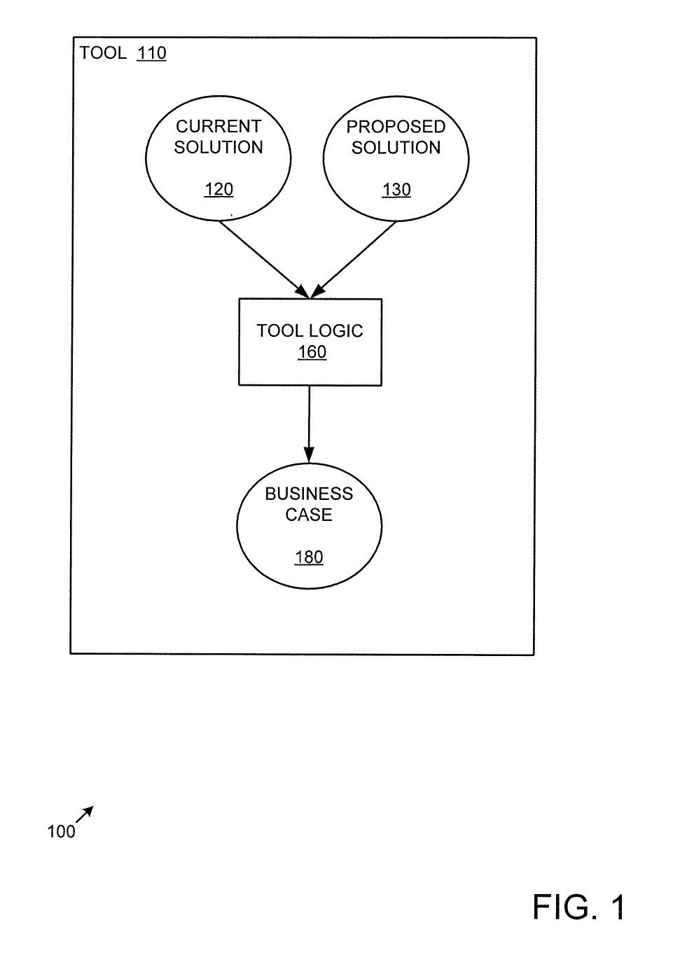

FIG. 1 is a block diagram of an exemplary system 100 implementing the strategic deal estimation technologies described herein. In the example, one or more computers in a computing environment implement tool 110 that accepts as input information 120 about a current solution and information 130 about a proposed solution. The tool 110 includes tool logic 160, which generates outputs a business case 180.

In practice, the systems shown herein, such as system 100 can be more complicated, with additional functionality, more complex inputs, and the like.

As described herein, the tool 110 can handle a plurality of service bundles and organizational towers, and the business case 180 can be organized accordingly.

In any of the examples herein, the inputs, outputs, and business case 180 can be stored in one or more computer-readable storage media.

### Example 3

### Exemplary Method of Applying a Combination of the Technologies

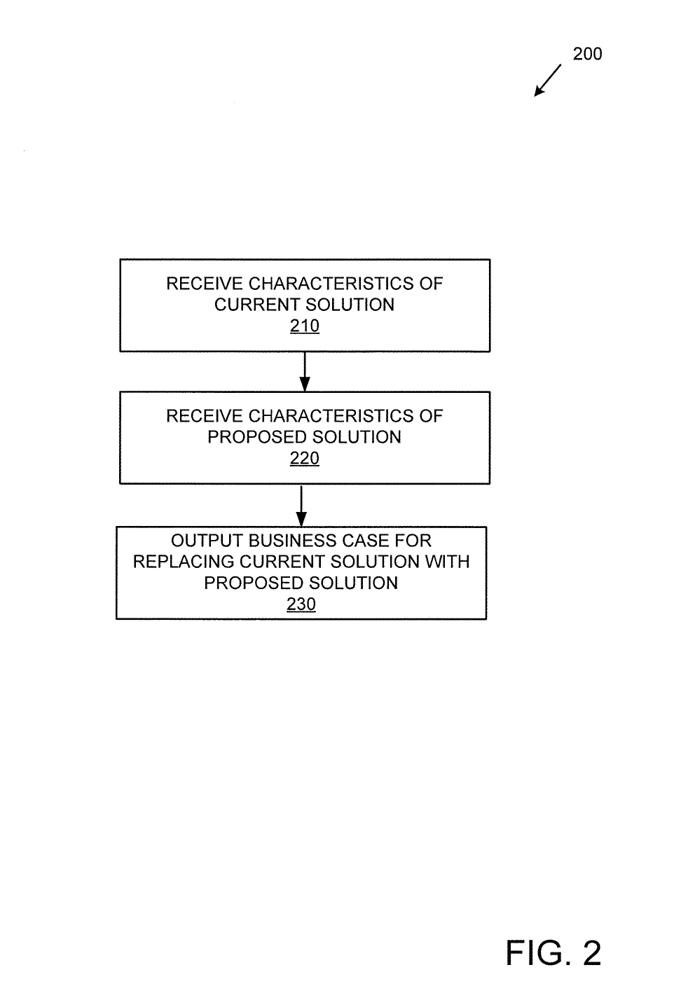

FIG. 2 is a flowchart of an exemplary method 200 of implementing the strategic deal estimation technologies described herein and can be implemented, for example, in a system such as that shown in FIG. 1. The technologies described herein can be generic to the specifics of operating systems or hardware and can be applied in any variety of environments to take advantage of the described features.

At 210, characteristics of a current solution implemented by a client are received. Such characteristics can include staffing information as described herein.

At 220, characteristics of a proposed solution proposed by the service provider are received. Such characteristics can include adjusted staffing information, various rates, costs, and the like.

At 230, a business case for replacing the current solution with the proposed solution is output.

The method 200 and any of the methods described herein can be performed by computer-executable instructions stored in one or more computer-readable media (e.g., storage or other tangible media) or stored in one or more computer-readable storage devices.

### Example 4

### Exemplary Solutions

In any of the examples herein, a solution can be any information technology services solution involving any of the service types described herein. The solution is sometimes called a “bid” or “deal.” The examples herein relate to global sourcing solutions.

A current solution is sometimes called the “as is” condition.

A proposed solution can be targeted to a current or prospective client as a result of a request for proposal (RFP), request for information (RFI), request for services (RFS), or other marketing effort. The proposed solution is sometimes all the “to be” condition.

### Example 5

### Exemplary Service Types

As part of a solution, technology process outsourcing services of any of a variety of technology process outsourcing service types can be provided. Examples include application development and maintenance (ADM), business process outsourcing (BPO), infrastructure managed services, (IMS) and the like.

### Example 6

### Exemplary Bundles

In any of the examples herein, a service bundle (or “bundle”) can represent services grouped together into a unit for purposes of organizing a proposal. Such groupings can reflect different service types, different sub-organizations within the client, or the like.

In practice, a bundle is referred to by a bundle name.

### Example 7

### Exemplary Towers

In any of the examples herein, to support modularity, in addition to bundles, the tool can represent organizational towers (or “towers”). A bundle can be associated with a tower to allow subtotals for a plurality of bundles. Such towers can represent the organizational structure of the client, such as geographical groupings (e.g., by location of client office), functional groupings, business unit groupings (e.g., by business line), technological groupings, or the like.

In practice, a tower is referred to by a tower name.

### Example 8

### Exemplary Full Time Equivalents

In any of the examples herein, employees can be measured and represented in terms of full-time equivalent employees (FTEs).

### Example 9

### Exemplary Staffing Resources Information

In any of the examples herein, staffing resources information or indications of staffing resources can include headcounts, hours worked, labor roles, or the like.

### Example 10

### Exemplary Labor Rates

In any of the examples herein, labor rates can indicate an amount paid for a unit of labor (e.g., hourly labor rate, monthly labor rate, or the like).

### Example 11

### Exemplary Productivity Gain Rates

In any of the examples herein, productivity gain rates can indicate an amount of productivity gain. For example, if more work can be done with the same number of people, or if the same amount of work can be done with fewer people, a gain in productivity is indicate. The productivity gain rate can indicate a ratio comparing present productivity with future or past productivity.

### Example 12

### Exemplary Time Series

In any of the examples herein, various numbers can be reflected in a time series. Such a time series can extend over the life of the proposed solution (e.g., a contract term). The series can be organized by year, half, quarter, month, or the like.

Any of the costs, employees, rates, and the like herein can be reflected in such time series.

For example, a time series can show expected costs over a period of time (e.g., a cost for year 1, a cost for year 2, a cost for year 3, and the like). Thus, the costs for a particular year can be reflected in the tool. Consequently, as described herein, a business case can reflect savings in a particular year and show progress of savings over time.

### Example 13

### Exemplary Business Cases

In any of the examples herein, a business case can reflect a persuasive description of why a current solution should be replaced with a proposed solution. Typically, the business case presents current solution spend, proposed solution spend, and a savings if the proposed solution were to be adopted (e.g., current solution spend minus proposed solution spend).

The business case can take the form of a global sourcing business case, with indications of offshoring characteristics (e.g., how many employees will be offshore).

### Example 14

### Exemplary Tool Logic

In any of the examples herein, tool logic can take a variety of forms, including formula calculation, value lookups, conditional statements, error processing, and the like.

### Example 15

### Exemplary Results

Although not always explicitly stated, in any of the examples herein, results of calculations can be displayed (e.g., on a page) for consideration by a user (e.g., a solution architect).

### Example 16

### Exemplary Overrides

In any of the examples herein, default parameters can be overridden by specification of custom parameters by a solution architect.

### Example 17

### Exemplary Pages

In any of the examples herein, related input parameters, outputs, subtotals, summaries, and the like can be presented on a page for consideration by a user. In practice, such pages can take a variety of forms, such as web pages, spreadsheet pages, and the like.

To facilitate navigation between pages, pages can be given a page name. For example, tabs displaying the page name can be used to navigate to the corresponding named page.

Pages can also be called “sheets” in keeping with a spreadsheet implementation or as a spreadsheet metaphor in a non-spreadsheet implementation.

### Example 18

### Exemplary Tools

In any of the examples herein, a tool can take the form of a spreadsheet, web application, cloud computing, etc. The tool can be implemented in any suitable computing environment. The tool is sometimes called a “strategic deal estimation tool” because it can estimate various aspects of a deal (e.g., providing a proposed solution).

### Example 19

### Exemplary General Process

The general process for assembling a proposal is to receive or estimate an indication of how many employees a client has in the current solution. The employees can be divided by bundles.

The process can estimate what would be the optimal offshore ratio for the personnel, what kind of annual productivity improvements are expected, what kind of labor roles there will be (e.g., how many are seniors, how many are juniors, how many are project managers, how many are technicians, etc.), what would be the labor rates for the roles (e.g., both onsite and offshore), how long would the transition to the new ratios take, what order it would be done in, how much it would cost, how much would be charged for it and account management office (AMO) and project management office (PMO). These items can be combined together into a solution summary that indicates what the month-to-month scenario is going to look like from month 1 to month n (e.g., the exact headcount, location, pricing, roles, etc.). Such a solution addresses the client's current environment and can be priced at a curtain amount, which is typically significantly less than what the client does it for currently.

The tool can allow dropdown choices to be able to select, and based on the selections, the tool can provide a recommendation for offsite/onshore ratios, productivity, labor roles and rate, AMO, PMO, and for the transition.

The tool can allow override for unique client situations. So, during the review process someone can look at a parameter (e.g., productivity improvement) and decide to use a different number (e.g., 3.5% instead of 4%). Specific parameters can be overridden without ruining the way the rest of the tool works. So, the tool can be more flexible and transparent, the solution architects can understand how it works, and they can ultimately come up with winning solutions.

### Example 20

### Exemplary System Calculating Current Solution Spend

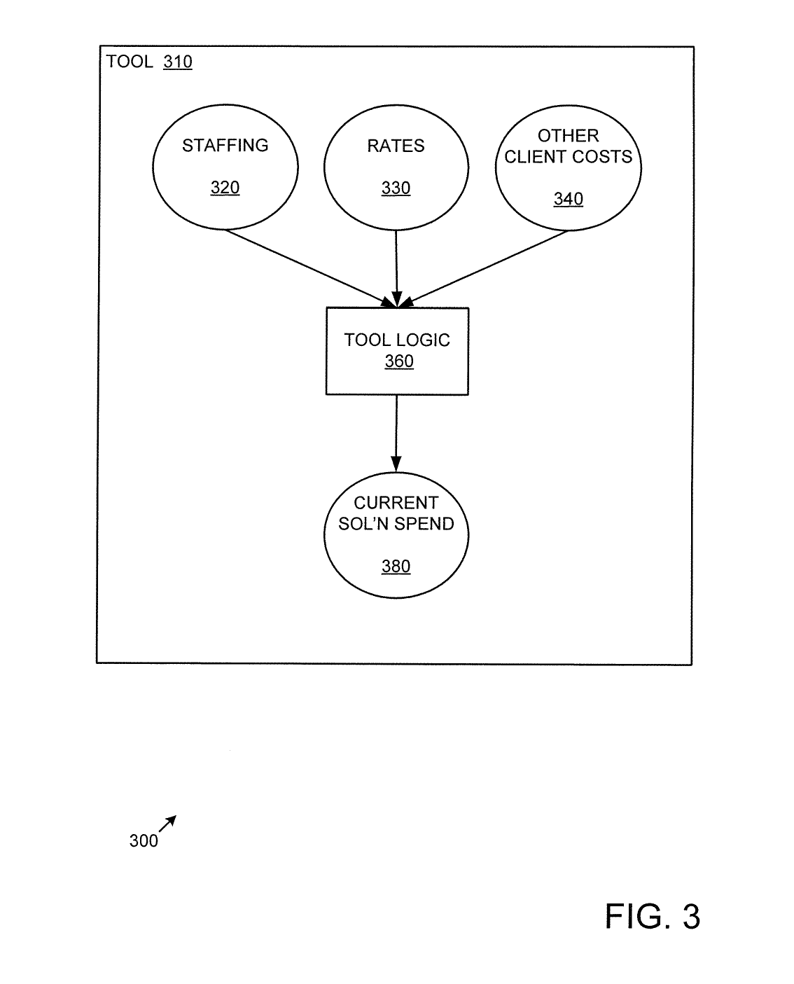

FIG. 3 is a block diagram of an exemplary system 300 calculating current solution spend based on characteristics of a current solution and can be implemented in any of the examples herein. Inputs to the tool logic 360 of the tool 310 can include staffing information 320, rates 330 (e.g., labor rates, and the like), and other client costs 340.

Using a variety of logic as described herein, the tool logic 360 outputs the current solution spend 380. The current solution spend 380 indicates the current cost of the information technology services solution that the client is currently implementing and can serve as a baseline against which comparisons can be made. The current solution spend 380 can be adjusted to reflect a standardized period (e.g., annual spend, fiscal year spend, or the like) to facilitate comparison. The spend can also be reflected over an extended time period (e.g., a period matching the proposed solution) on an annual, half, or monthly basis.

As described herein, a variety of features can facilitate more accurate and consistent determination of a client's current solution spend. For example, cost of living adjustments and other features can be implemented.

### Example 21

### Exemplary Method of Calculating Current Solution Spend

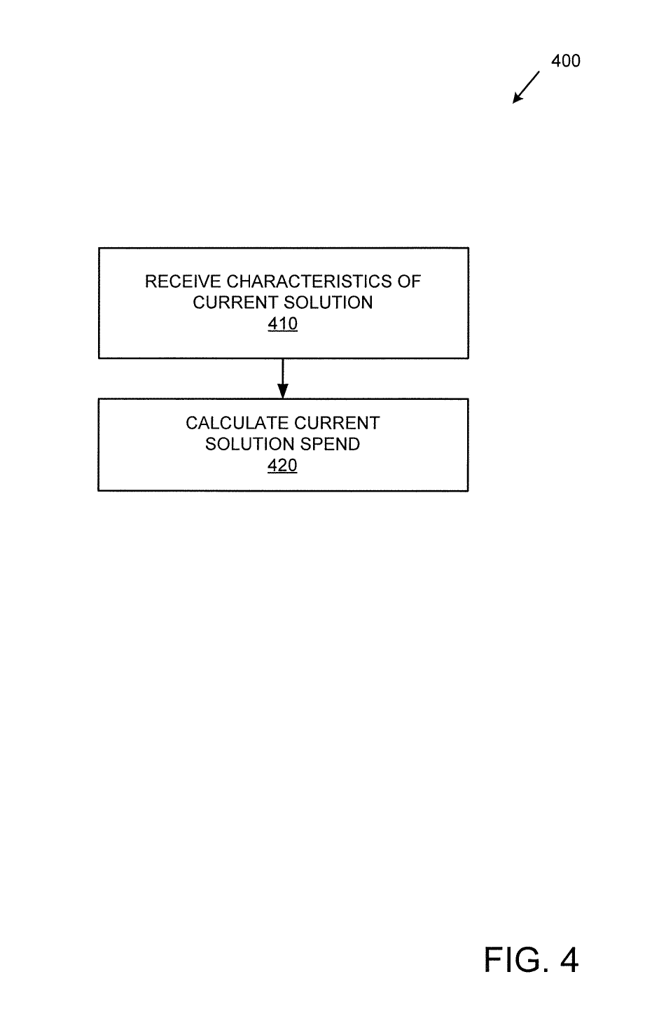

FIG. 4 is a flowchart of an exemplary method 400 of calculating current solution spend based on characteristics of a current solution and can be implemented, for example, in a system such as that shown in FIG. 3.

At 410, characteristics of a current solution are received. Such characteristics can include staffing information, rates (e.g., labor rates, productivity gain rates, and the like), and other client costs.

At 420, the current solution spend is calculated. In practice, a variety of information can be included in the calculation. For example, received staffing information can categorize staff according to their offsite/onshore status, vendor status, and the like (e.g., whether an employee is a client employee onsite, a client employee offshore, a vendor employee onsite, a vendor employee offshore, or the like). The current solution spend represents an educated estimate of the current amount that the client is spending for the current solution.

For staffing estimates, in addition to understanding the location of a client's current staffing resources and the job roles performed, an approximation of the cost per resource can be estimated based off of geographical location and an assumed years of experience required to perform the necessary tasks to perform the work.

As described herein, the current solution can be divided in to a plurality of bundles and organized by towers. In such a case, the input can be separated by bundle, and the current solution spend can be calculated separately for the bundles, for the towers, and in total.

### Example 22

### Exemplary System Calculating Proposed Solution Spend

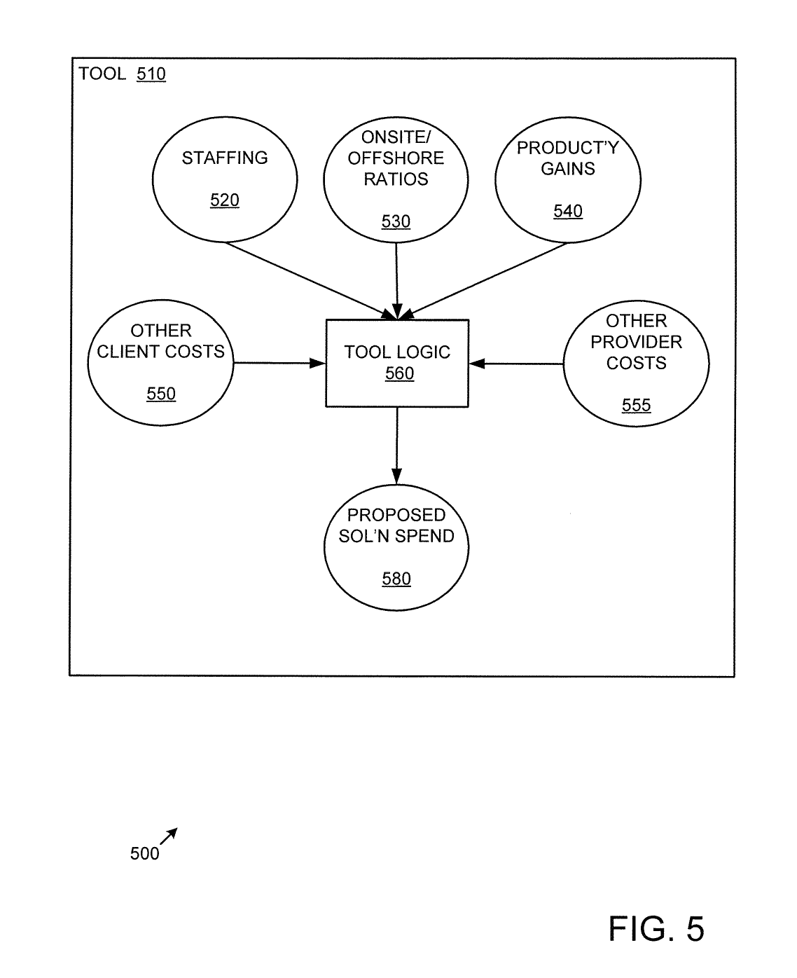

FIG. 5 is a block diagram of an exemplary system 500 for calculating proposed solution spend 580 based on characteristics 520, 530, 540, 550, 555 of a proposed solution and can be implemented in any of the examples herein. In the example, the tool logic 560 of tool 510 is used to generate proposed solution spend 580 based on input of the characteristics.

Input characteristics can include staffing information 520 (e.g., regarding the current solution), onsite/offshore ratios 530, productivity gains 540, other client costs 550, and other provider costs 555 as described herein.

The proposed solution spend 580 indicates the estimated cost of the information technology services solution being proposed to replace the current solution and can be compared against the current spend. The proposed solution spend can be adjusted to reflect a standardized period (e.g., annual spend, fiscal year spend, or the like) to facilitate comparison. The spend can also be reflected over an extended time period (e.g., a period matching the proposed solution) on an annual, half, or monthly basis.

As described herein, a variety of features can facilitate more accurate and consistent determination of proposed solution spend.

The tool 510 can provide a rich set of features for creating, evaluating, adjusting, and comparing solutions. For example, a user can quickly create a proposed solution and adjust it to reflect the peculiarities of a particular client.

### Example 23

### Exemplary Method of Calculating Proposed Solution Spend

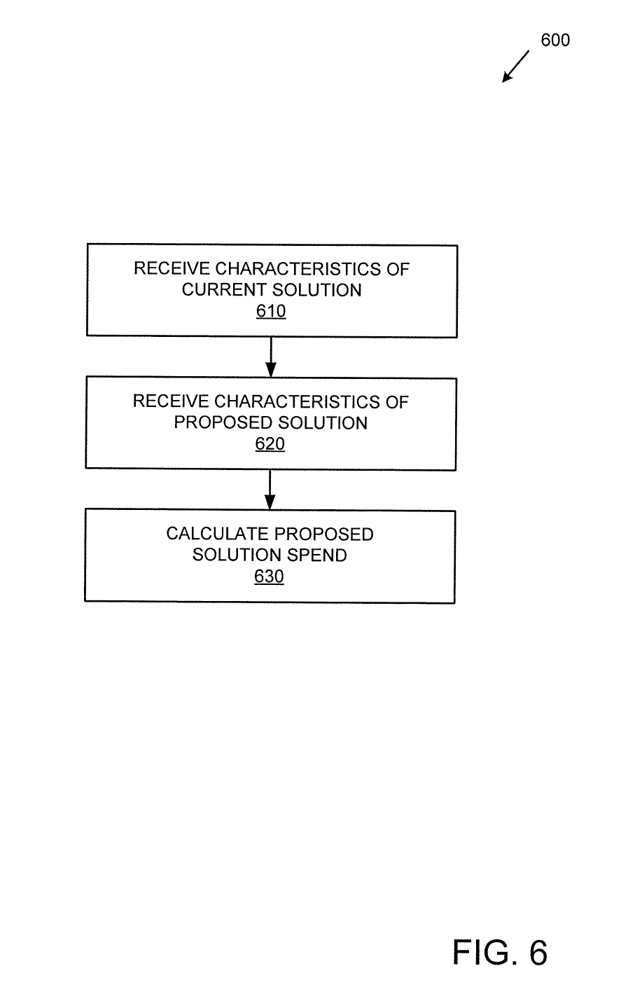

FIG. 6 is a flowchart of an exemplary method 600 of calculating proposed solution spend based on characteristics of a proposed solution and can be implemented, for example, in a system such as that shown in FIG. 6.

At 610, characteristics of a current solution are received. For example, staffing information for a current solution can be received.

At 620, characteristics of a proposed solution are received.

At 630, the proposed solution spend is calculated. For example, based on the staffing information for the current solution, altered staffing information for a proposed solution can be generated (e.g., based on onsite/offshore ratios). Productivity gains can also be factored in. Other client costs and other provider costs as described herein can be taken into account to more accurately reflect the proposed solution spend.

In addition to applying productivity estimates to the current staffing levels to determine future staffing requirements, a proposed mix of onsite and offshore locations will assist the client in recognizing business value savings from current spend levels. A proposed mix of job roles with applicable supervisory ratios (e.g., how many project managers per full time equivalent) is also chosen to provide savings.

As described herein, the proposed solution can be divided in to a plurality of bundles and organized by towers. In such a case, the input can be separated by bundle, and the proposed solution spend can be calculated separately for the bundles, for the towers, and in total.

### Example 24

### Exemplary Features Supporting the Proposal Process

The proposed solution generation process can take an iterative form where the solution architect adjusts various solution parameters, evaluates the solution, and again adjusts the solution parameters until it is determined that the proposed solution is satisfactory. Buy in from a solution architect with experience in the field, as well as the service delivery team can be obtained.

Various output from the tool can then be incorporated into a formal proposal.

Various features described herein can be used to enhance the basic process of building a business case. Any of the examples herein can be incorporated into a tool with advantage, or included in any of a variety of combinations as desired.

### Example 25

### Exemplary Default Parameters

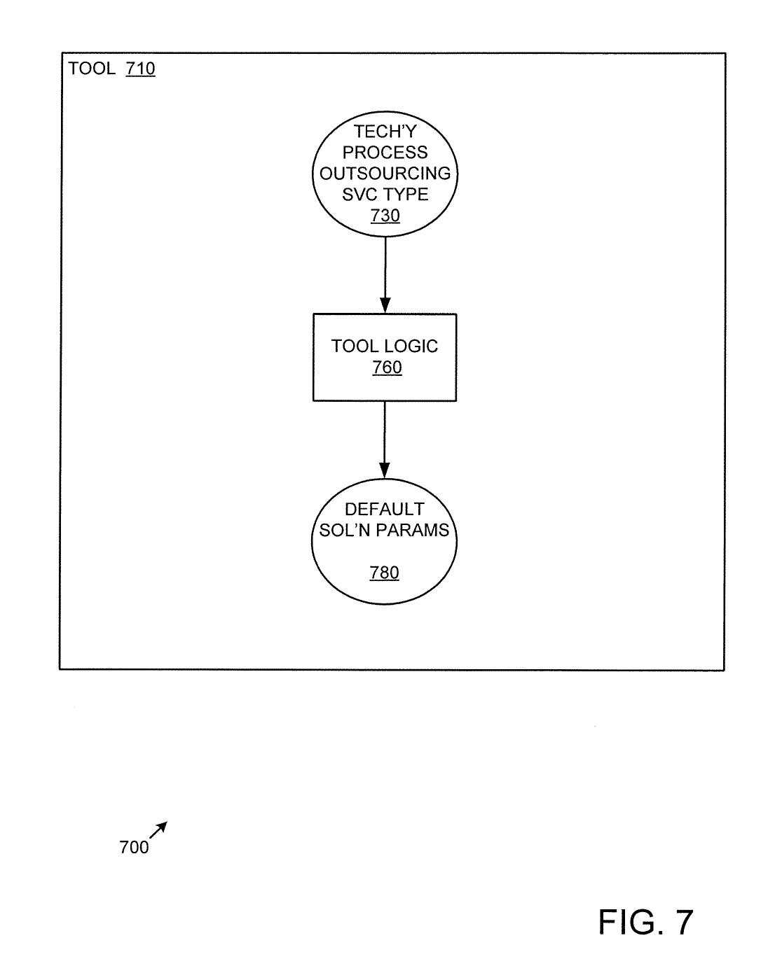

FIG. 7 is a block diagram of an exemplary system 700 supporting default solution parameters based on technology process outsourcing service type. In the example, tool logic 760 of a tool 710 receives an indication of a technology process outsourcing service type 730 and outputs default solution parameters 780.

### Example 26

### Exemplary Method for Selecting Default Parameters

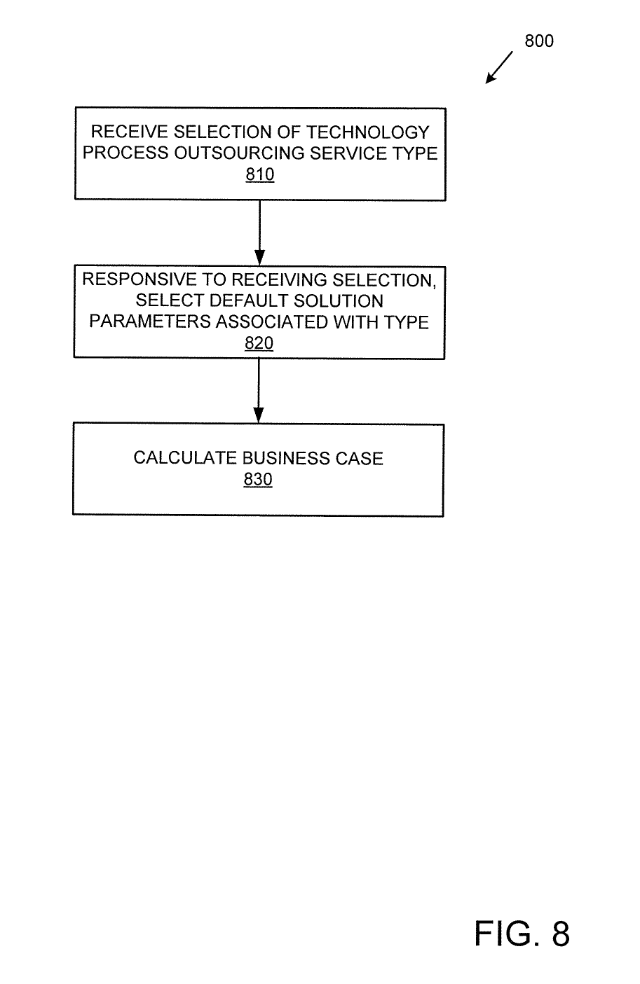

FIG. 8 is a flowchart of an exemplary method 800 of selecting default solution parameters based on technology process outsourcing service type.

At 810, a selection of technology process outsourcing service type for a proposed solution is received. As described herein, such selection can be received by selection from a dropdown menu listing possible service types.

At 820, responsive to the selection, default solution parameters associated with the selected type are selected. In practice, the parameters can then be incorporated into the tool and affect the proposed spend. Selections of different types can result in different default parameters. Some types may have no default parameters.

To facilitate flexibility, the default solution parameters can be adjusted as appropriate (e.g., according to the particularities of a particular client or solution).

To facilitate modularity, the method 800 can be implemented separately per bundle. So, for example, different service types can be selected for different bundles, and the resulting default parameters can be associated with the respective bundle.

At 830, a business case is calculated as described herein. The default solution parameters affect the business case because they affect the proposed solution spend. In the case of a bundle, the proposed solution spend for the particular bundle is affected.

### Example 27

### Exemplary Default Parameters

As described herein, default solution parameters described herein can include offshore ratios, onsite ratios, productivity gain ratios, labor roles, labor rates, transition costs, account management office (AMO) costs, and project management office (PMO) costs.

Such parameters can include one or more parameter series, such as parameters in a time series (e.g., a ratio that increases or decreases over time, a productivity gain ratio that recurringly alternates between 0 and a number, or any other series). The series of default parameters can be limited to the length of the proposed solution (e.g., as indicated in the tool).

In the case of onsite or offshore ratios, the default parameters can include a time series increasing or decreasing over time during the life of the proposed information technology services solution. Such parameters can be based on validated historical experience for the particular service selected in a bundle. Different bundles can have different onsite or offshore ratios according to the services selected for respective bundles.

In the case of a productivity gain ratio, the default parameters can include a time series showing occasional increases in productivity during the life of the proposed solution.

If a service type has no default parameters, further information can be collected to determine appropriate parameters. The user interface areas of a tool that are for collecting such information can be obfuscated (e.g., greyed out) in the case of a service that does have default parameters.

### Example 28

### Exemplary System Allocating Client Costs

An accurate business case can be better constructed if an accurate portrayal of client costs is reflected by the tool.

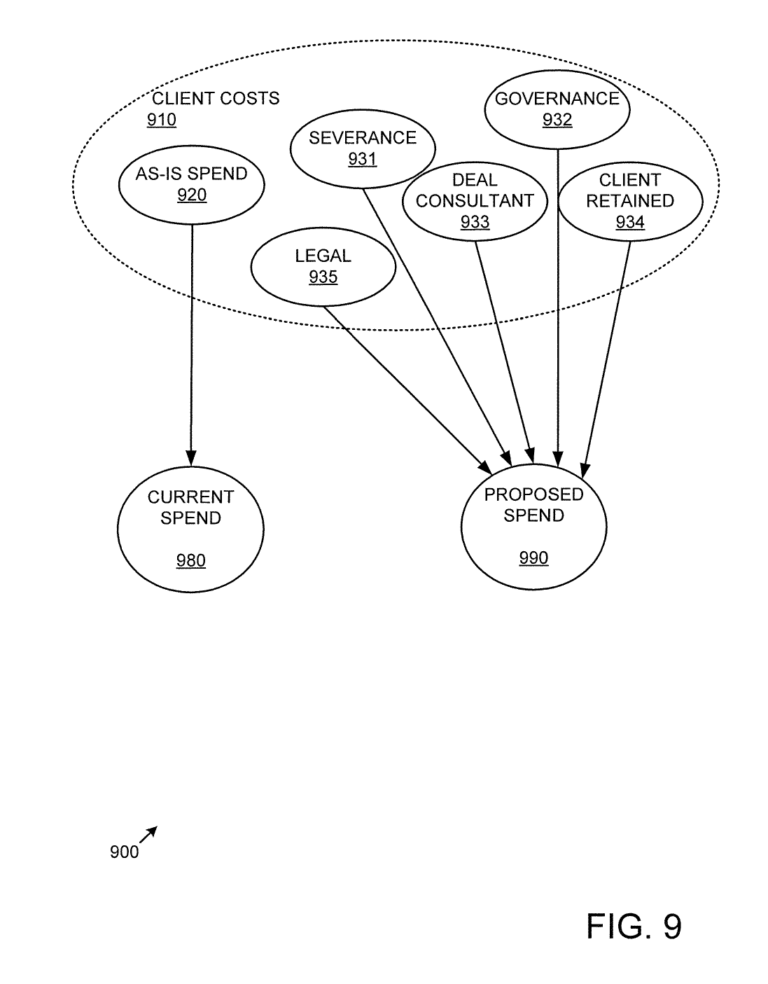

FIG. 9 is a block diagram of an exemplary system 900 allocating client costs, which can be used in any of the examples herein. In the example, there are various client costs 910, such as as-is spend 920, severance 931, governance 932, deal consultant 933, client retained employees 934, and legal 935. The client costs 910 are included in the current solution spend 980 or the proposed solution spend 990 based on the type of client cost.

Including such costs can build credibility in the eyes of the client because it provides a more realistic proposal and business case without ignoring some costs that might be overlooked or hidden by other service providers.

### Example 29

### Exemplary Method of Allocating Client Costs

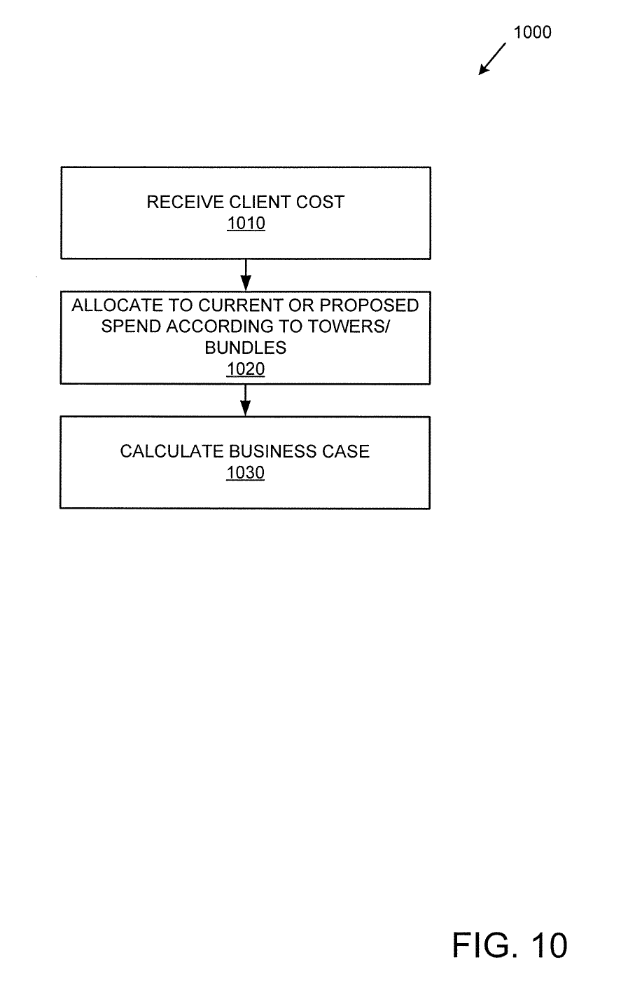

FIG. 10 is a flowchart of an exemplary method 1000 of allocating client costs.

At 1010, a client cost is received; the client cost is of a client cost type, which can be reflected explicitly or by virtue of where it appears (e.g., in which table, cell, or the like). The client cost can be received from calculations on other inputs as described herein. As described herein, the client costs can be organized to display on a single page for convenience sake, even if some of the data is based on information on other pages. Various input parameters for severance, governance, deal consultant, client retained employees, and legal costs can also be organized on the single page for the sake of convenience and transparency. A determination of how to calculate the client cost from the input parameters can be based on the client cost type.

At 1020, a choice is made to allocate the client cost to the current solution spend or the proposed solution spend according to the client cost type. As described herein, allocation can be done on a bundle-by-bundle basis and be reflected in tower totals. Allocation can include calculations according to the client cost type. For example, client costs for severance can be performed differently than client costs for governance. A time series of costs can be generated, with certain costs (e.g., severance) non-uniformly spread out over the life of the proposed solution.

At 1030, a business case for the proposed solution is calculated. The business case can reflect whether a client cost has been allocated as part of the current solution spend or the proposed solution spend.

Any of the client costs shown in FIG. 9 can be used.

The as-is spend can reflect the amount of spending that would be projected over the life of the solution if the current solution were kept in place. The as-is calculation can take an input of the number of employees in a particular onshore/offshore/client/vendor category, determine a number of hours for the employee (e.g., based on number of hours projected per year), and multiply it by a labor rate for the particular category.

The severance costs can reflect the amount of spending that would be projected for paying severance to displaced employees if the proposed solution were to be adopted. The severance calculation can be performed for both current onsite and current offshore employees. The calculation can accept an hourly cost, number of employees severed, and months of severance. The calculation thus takes the form of multiplying for both current onsite and current offshore employees and adding the results together.

The governance costs can reflect the amount of spending that would be projected for maintaining a governance presence to manage the proposed solution if the proposed solution were to be adopted. It can be based on the number of employees projected to be required for governance, an hourly rate, and projected number of hours (e.g., per time period, such as year).

The deal consultant costs can reflect the amount of spending that would be projected for hiring a deal consultant if the proposed solution were to be adopted.

The client retained employee costs can reflect the amount of spending that is projected for keeping a certain number of client/vendor employees in place if the proposed solution were to be adopted. The retained employee costs can further be broken down into “during transition” and “post transition.” Accordingly, the client retained employee costs calculation can take into account the transition period and determine costs during transition and the steady state reached after transition has occurred.

The legal costs can reflect the amount of spending by the client that would be projected for hiring lawyers or buying legal services if the proposed solution were to be adopted.

Any of the costs can be reflected as a time series.

Costs can also be summarized per bundle, per tower, and the like.

### Example 30

### Exemplary System Designating Provider Costs According to Billability

The tool can provide flexibility regarding whether provider costs are to be billed to a client as part of providing the proposed solution.

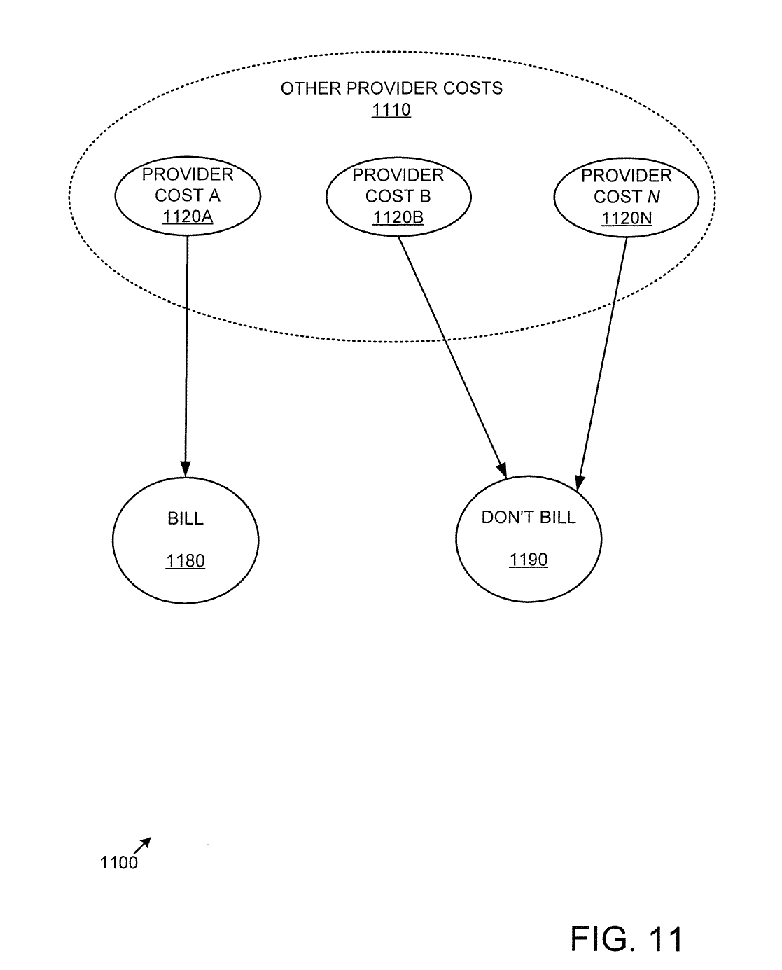

FIG. 11 is a block diagram of an exemplary system 1100 designating provider costs 1110 according to whether they are to be billed to a client. In the example, there are various provider costs 1120A, 1120B, and 1120N. The provider costs 1110 are allocated as billable 1180 or non-billable (e.g., overhead) 1190 items based on an indication provided to the tool by a user.

### Example 31

### Exemplary User Interface Designating Provider Costs According to Billability

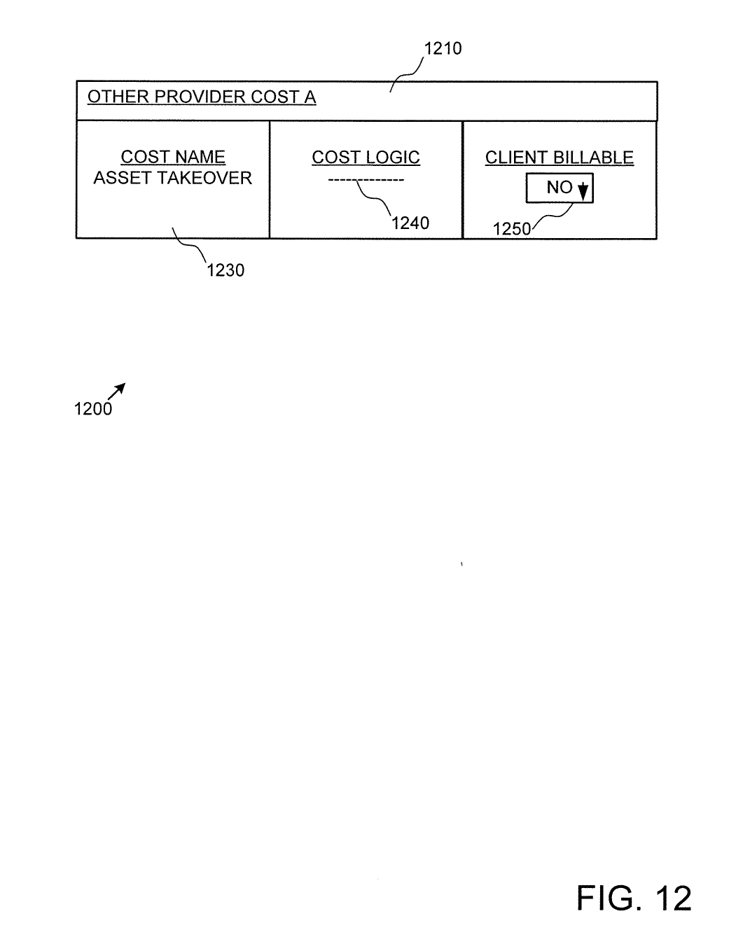

FIG. 12 is a screen shot of an exemplary user interface 1200 for designating provider costs according to whether they are billed and can be implemented, for example, in a system such as that shown in FIG. 11.

In the example, an entry 1210 (e.g., row) for an other (e.g., non-FTE) provider cost item is shown. There can be a plurality of entries for respective other provider costs. Associated with the entry 1210 is a cost name 1230, cost logic 1240, and a user interface element 1250 for indicating whether the cost is client billable or not. In practice, the user interface element 1250 can be a dropdown list, radio button, or checkbox that permits selection between two options (e.g., yes/no, billable, not billable). The two options can be represented by a single item (e.g., a check box named “billable” can indicate both billable by being checked and non-billable by being unchecked).

The cost logic 1240 can differ depending on the type of other provider cost represented.

### Example 32

### Exemplary Method of Designating Provider Costs According to Billability

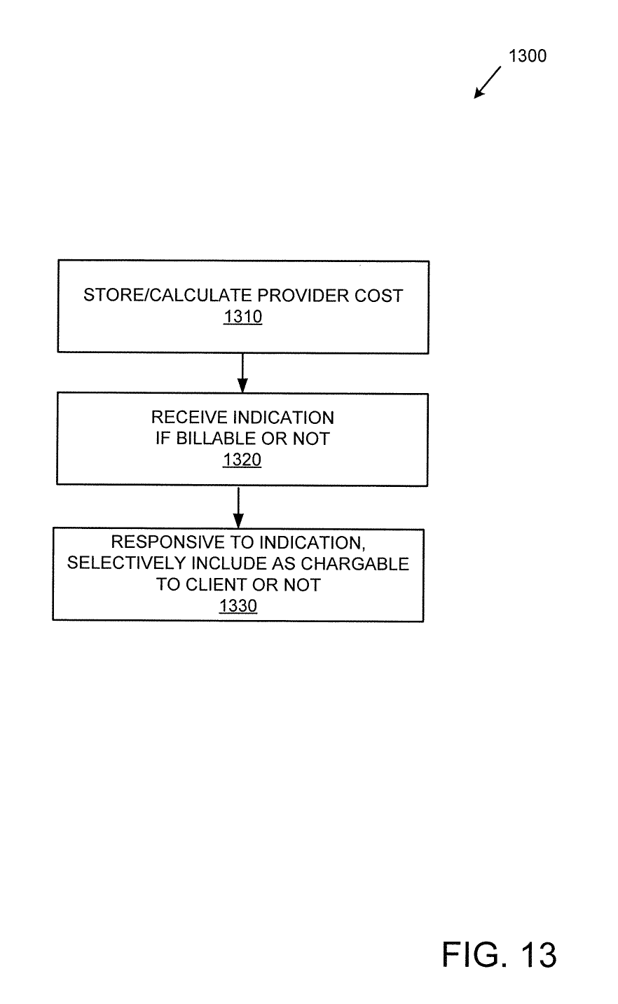

FIG. 13 is a flowchart of an exemplary method 1300 of designating provider costs according to whether they are billed, for example via the user interface of FIG. 12.

At 1310, a provider cost is stored, calculated, or both. Calculations can vary depending on the provider cost type.

At 1320, an indication of whether the provider cost is billable or not is received.

At 1330, responsive to the indication, the cost can be selectively included as chargeable to the client or not. Such selective inclusion can affect where or whether the cost appears in a different page or category. In the case of a cost that is chargeable to the client, it is included in the proposed solution spend. A cost that is not chargeable to the client is not included in the proposed solution spend. Non-chargeable costs may appear in other analyses (e.g., profit margin).

Various provider costs can include travel related costs, communication costs, asset takeover costs, non-standard hardware and software, software development, rebadge costs, and open (e.g., miscellaneous) costs.

Any of the costs can be reflected as a time series.

### Example 33

### Exemplary System Comparing Bids

Taking incumbency into account when comparing predicted bids of competitors leads to more accurate comparisons between vendors and result in a higher proposal success rate.

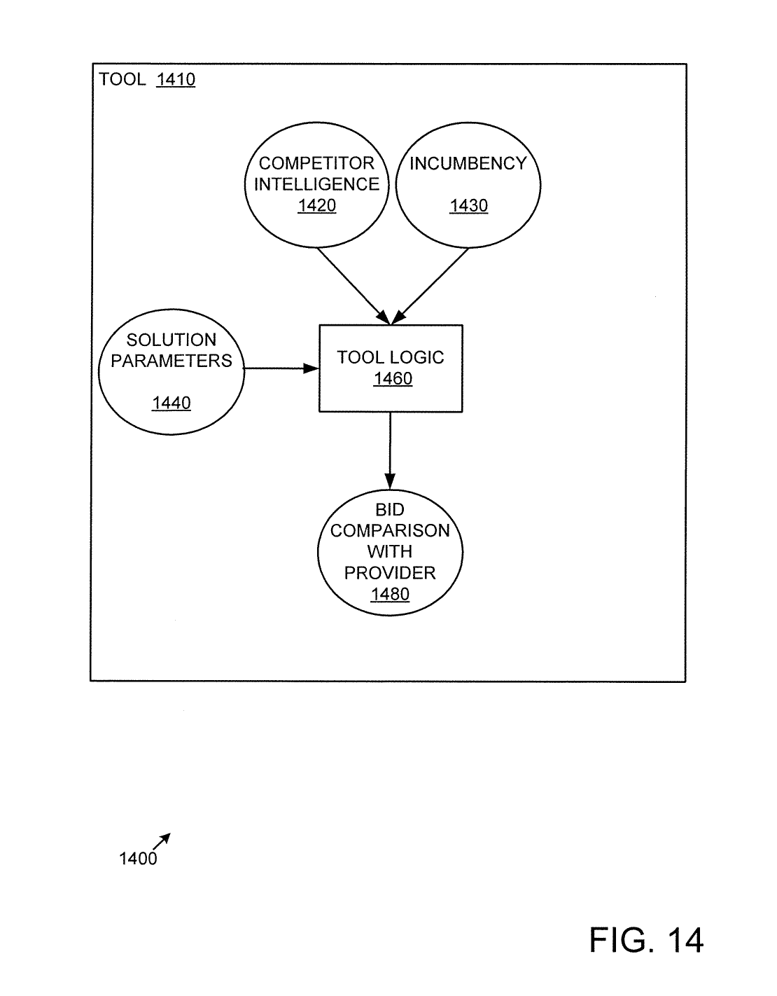

FIG. 14 is a block diagram of an exemplary system 1400 comparing a provider's bid with bids of competitors, taking incumbency 1430 into account.

In the example, the tool logic 1460 of tool 1410 takes competitor intelligence and an indication of incumbency for the proposed solution as inputs, along with the proposed solution parameters 1440.

The output is a bid comparison involving comparison of predicted bids by possible competitors with the currently represented bid of the provider (e.g., who is using the tool). The comparison takes incumbency into account, adjusting transition and other costs in light of incumbency.

### Example 34

### Exemplary User Interface Comparing Bids

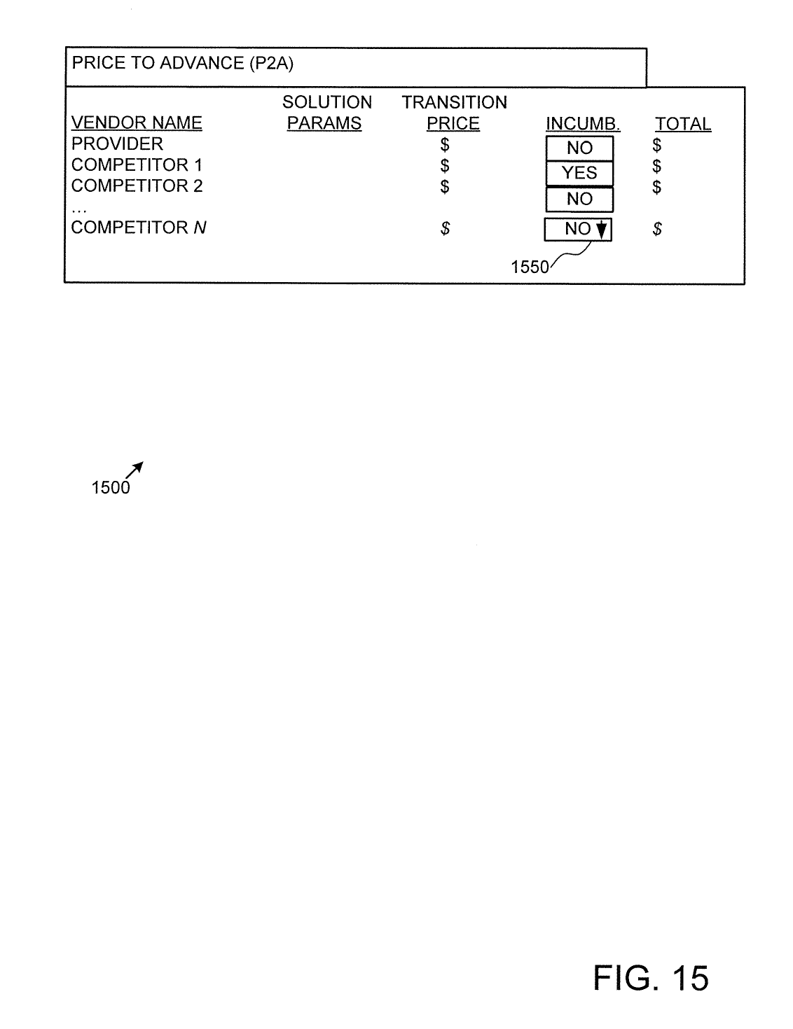

FIG. 15 is a screen shot of an exemplary user interface 1500 for comparing a provider's bid with bids of competitors, taking incumbency into account and can be implemented, for example, in a system such as that shown in FIG. 14. Because the proposed solution is often part of a process that continues on to a second stage of fewer bidders if approved, the comparison is sometimes shown as “Price to Advance” (P2A).

In the interface 1500, providers are listed as entries in a table that includes the vendor name, vendor-specific solution parameters, a transition price, and a total. There is also a user interface element 1550 that is operable to receive a selection indicative of whether the provider is the incumbent provider. In practice, the user interface element 1550 can be a dropdown menu (e.g., listing possible choices), radio button, or checkbox that permits selection between two options (e.g., yes/no, incumbent, not incumbent). The two options can be represented by a single item (e.g., a check box named “incumbent” can indicate both incumbent by being checked and non-incumbent by being unchecked).

### Example 35

### Exemplary Method of Comparing Bids

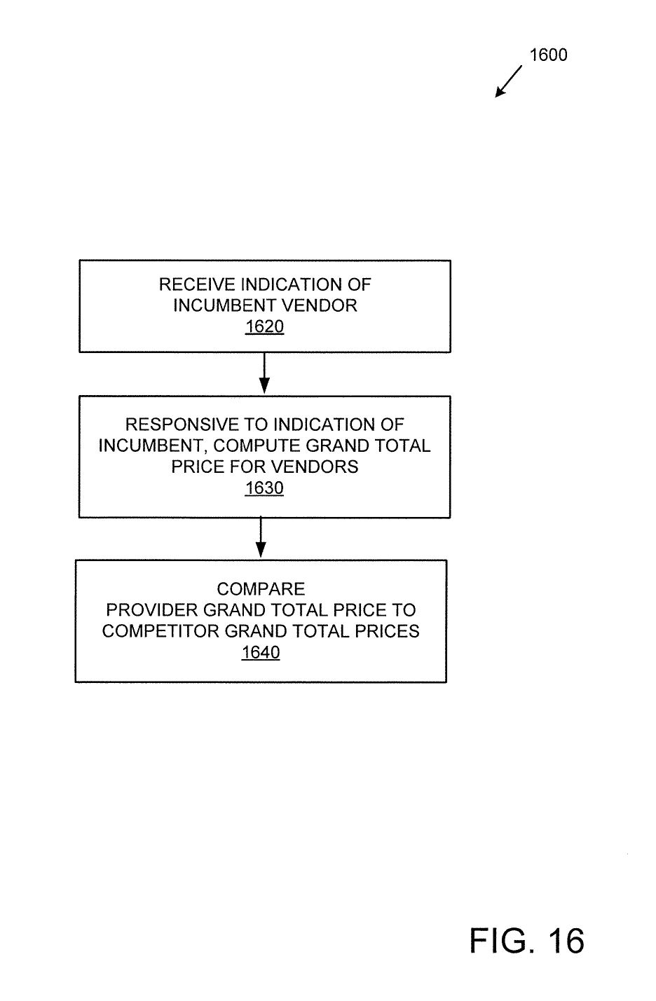

FIG. 16 is a flowchart of an exemplary method 1600 of comparing a provider's bid with bids of competitors, taking incumbency into account, for example via the user interface of FIG. 15.

At 1620, an indication of the incumbent vendor is received. For example, the user interface element shown in FIG. 15 can be used to indicate which vendor is the incumbent. The provider vendor or any of one or more competitors can be so indicated.

At 1630, responsive to the indication of the incumbent, the grand total solution price for vendors (the provider and one or more competitor vendors) is calculated taking incumbency into account (e.g., the transition costs for the incumbent vendor are adjusted). Such calculations can be based on the solution parameters and competitor intelligence. Typically, an incumbent vendor will have no or lower transition costs than non-incumbents.

When a vendor is the incumbent and there is no additional scope of work, then transitions costs are non-existent. When new scope is involved, the scope is split into logical groupings based on how a client's technology is organized by application, and then the number of resources performing the work currently is factored into estimating the duration required to accurately perform a seamless and non-disruptive transition for a client. The cost is calculated as a combination of people resources involved and the duration estimate required which typically is done in a few months.

The grand total price for competitor vendors represents an intelligent prediction of the competitor's solution price, taking incumbency into account. Based on legitimately gathered intelligence from credible sources, the tool can include data reflecting competitor intelligence. For example, competitor A may have a more aggressive stance toward outsourcing than the provider, and competitor B may have a more aggressive stance toward onsite vendor rates than the provider. So, for example, ratios indicating a predicted stance (e.g., 1.05 for a 5% higher prediction) vis-à-vis the provider's numbers. The tool can then multiply various solution parameters against competitor adjustment ratios, resulting in vendor-specific solution parameters, from which the grand total can be computed.

The tool can accept modifications of ratios or the calculated vendor-specific solution parameters to flexibly accommodate the peculiarities of a particular solution situation. The grand total calculations can be done based on such modifications.

At 1640, a grand total price of the provider is compared to grand total prices of one or more respective competitor vendors. Comparison can take the form of dollar comparisons, percentage comparisons, or the like, showing differences between grand total prices. The comparison results can be displayed. For example, for any vendor that is underbidding the provider, a negative percentage can be shown to indicate how much under the provider the competing vendor is.

Of course, in practice, it may not be a goal to be the lowest bidder. A provider may have other offerings such as quality, reliability, depth of service, reputation, and the like. However, having a full picture of where competitors are likely to position themselves in the bidding process can result in a more informed proposed solution that is likely to address client concerns and win the bid.

### Example 36

### Exemplary System Supporting Transition Scenarios

Clients can be attentive to transition costs and may be disappointed if transition costs are billed when they are incurred (e.g., at the beginning of the solution term). Accordingly, the tool can handle a variety of transition scenarios as part of the proposed solution engineering process.

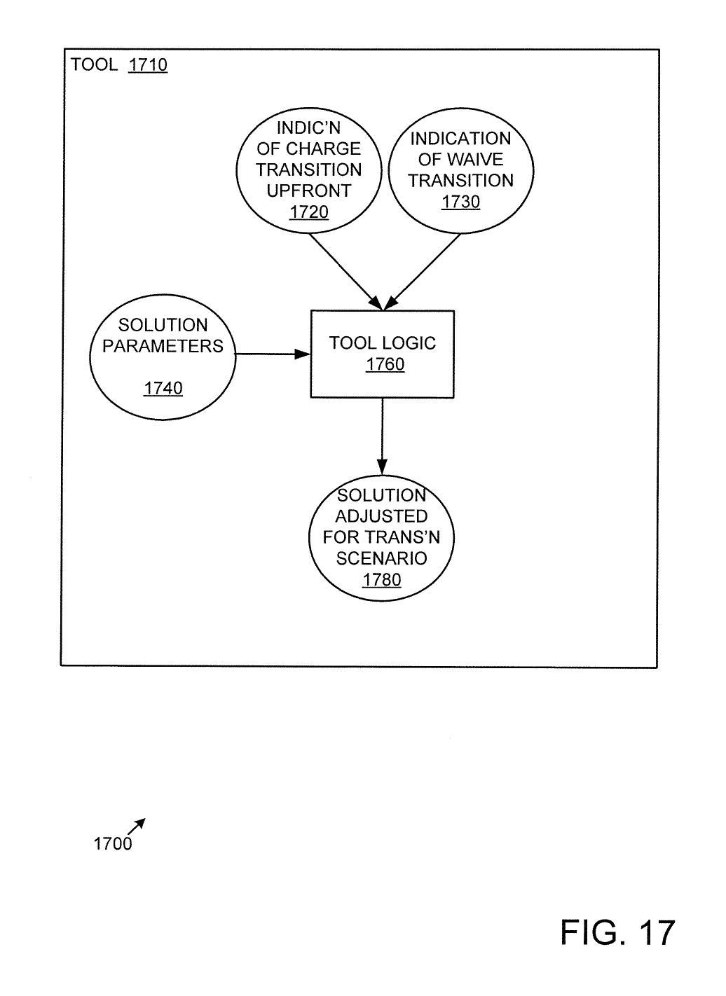

FIG. 17 is a block diagram of an exemplary system 1700 adjusting a solution based on a selected transition scenario. In the example, the tool logic 1760 of tool 1710 accepts an indication of whether transition costs are to be charged upfront 1720 (or, alternatively, spread out over time) and an indication of whether transition costs are to be waived 1730 as input, as well as the solution parameters 1740.

The output is a proposed solution adjusted in light of the transition scenario indicated by the indications 1720, 1730.

### Example 37

### Exemplary User Interface Supporting Transition Scenarios

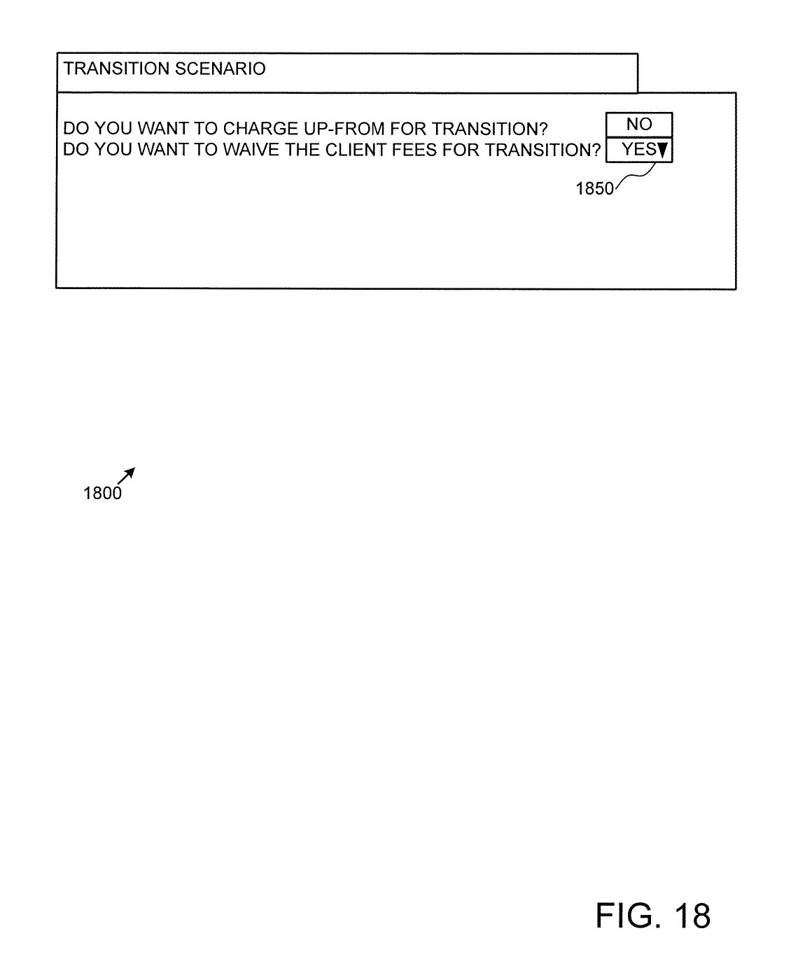

FIG. 18 is a screen shot of an exemplary user interface 1800 for adjusting a solution based on a selected transition scenario and can be implemented, for example, in a system such as that shown in FIG. 17.

In the example, a user interface element 1850 can be used whether transition costs are to be waived. Another user interface element can be used to indicate whether the transition costs are to be charged up-front (or, instead spread out over time).

In practice, the user interface elements can be combined together (e.g., as a single dropdown menu box, group of radio buttons, or the like).

### Example 38

### Exemplary Method of Supporting Transition Scenarios

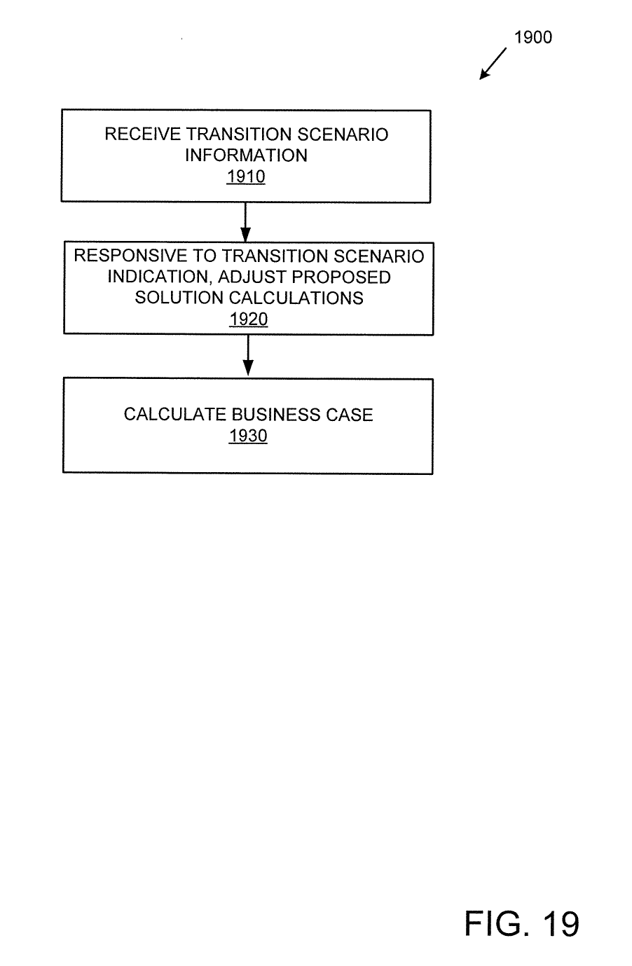

FIG. 19 is a flowchart of an exemplary method 1900 of adjusting a solution based on a selected transition scenario, for example via the user interface of FIG. 18.

At 1910, transition scenario information is received. For example, user interface elements can receive indications of whether transition costs are to be charged up front, whether transition costs are to be waived, and the like.

Transition costs are predominantly comprised of labor costs to transfer knowledge and processes from the current organization to the new organization. Additional costs incurred in a transition will also include travel and miscellaneous infrastructure requirements.

Responsive to the transition scenario indication (e.g., receipt of indication by the user interface element), the business case can be re-calculated. For example, at 1920, the proposed solution calculations can be adjusted. If transition costs are to be charged up front, they can be included in the first time period of the proposed solution or when they are incurred. If transition costs are not to be charged up front, they can be spread out over the course of the proposed solution (e.g., or some other term beyond the transition itself).

If transition costs are to be waived, they can be removed from the calculations, resulting in a lower proposed solution spend.

At 1930, the business case is calculated based on the adjusted proposed solution calculations. The business case can be displayed showing savings over time if the proposed solution were to be adopted. The savings can reflect having spread the transition costs over the term of the proposed solution.

The ability to quickly toggle between various transition scenarios can be particularly useful to do a what-if analysis of any proposed solution.

### Example 39

### Exemplary System Determining Solution Price Details

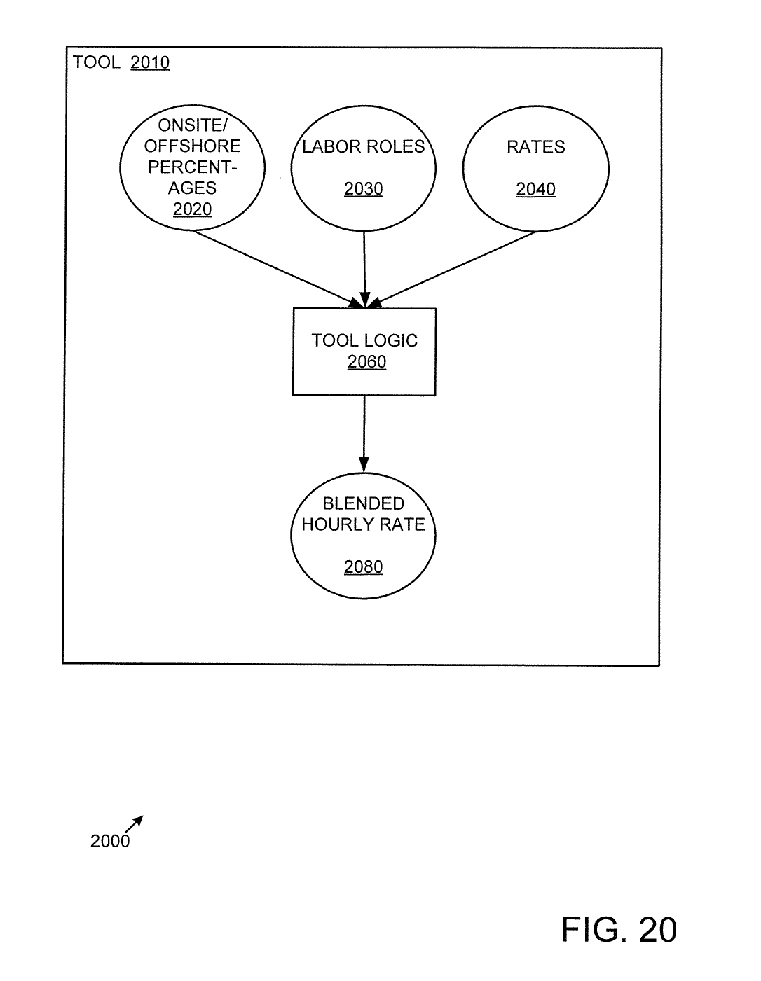

FIG. 20 is a block diagram of an exemplary system 2000 determining solution price details. In the example, inputs to the tool logic 2060 of the tool 2010 can include onsite/offshore percentages 2020, labor roles 2030, and labor rates 2040.

Output can include a blended hourly rate 2080. A variety of other outputs can be supported, such as towerwise price, and the like.

### Example 40

### Exemplary Method of Determining Solution Price Details

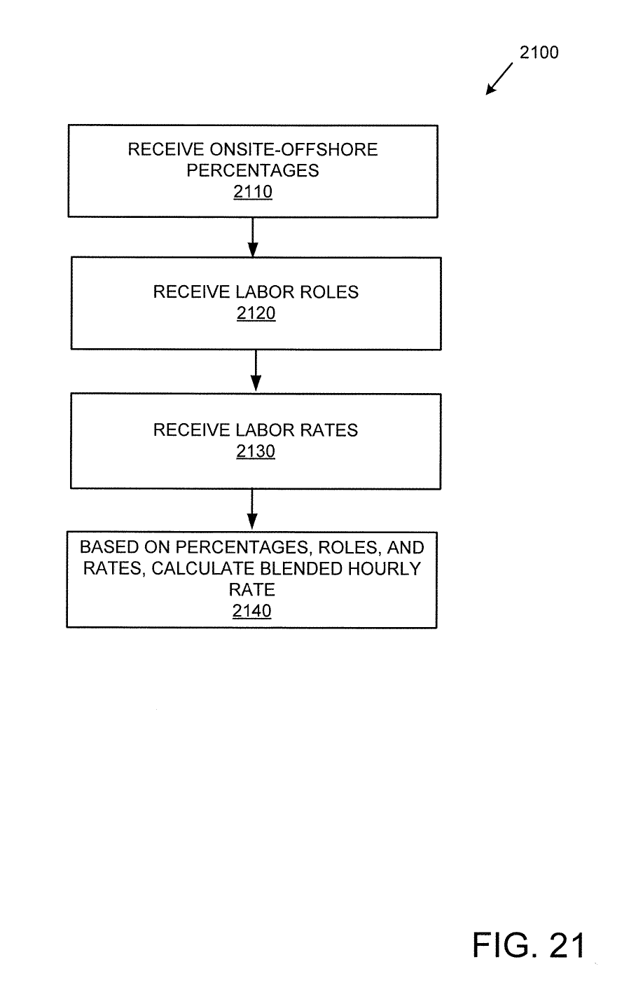

FIG. 21 is a flowchart of an exemplary method 2100 of determining solution price details for a proposed solution and can be implemented, for example by the system of FIG. 20.

At 2110, onsite-offshore percentages for a proposed solution are received. As described herein, such percentages can be default, calculated based on answers to questions, input manually, or the like. The percentage can indicate a distribution of employees between onsite status and offshore status (e.g., 90% onsite/10% offshore, 50% onsite/50% offshore, 30% onsite/70% offshore, or the like).

At 2120, labor roles for the proposed solution are received. Labor roles can indicate how many employees of various roles are expected to be included as part of the proposed solution and for what periods of time.

At 2130, labor rates for the proposed solution are received. The labor rates can differ for different respective labor roles.

At 2140, based on the percentages, roles, and rates, a blended hourly rate is calculated. The blended hourly rate can be a weighted rate indicating an overall labor rate (e.g., per hour). Weighting can be weighted according to the number of employees in a role (e.g., what percentage of the employees are in a particular role), the number of hours (e.g., how many hours are worked by employees of a particular role), or the like. The blended hourly rate can be displayed.

In addition, a towerwise price can be calculated and shown. For example, a blended rate per tower, total proposed solution price per tower, or the like can be shown.

The price details can be displayed on a single page for reference by a solution architect. Having such information on a single page, along with an indication of how such numbers were calculated can be of great assistance during the bidding process to provide an overall feel of the overall value and competitiveness of a proposed solution.

### Example 41

### Exemplary System Determining Business Case

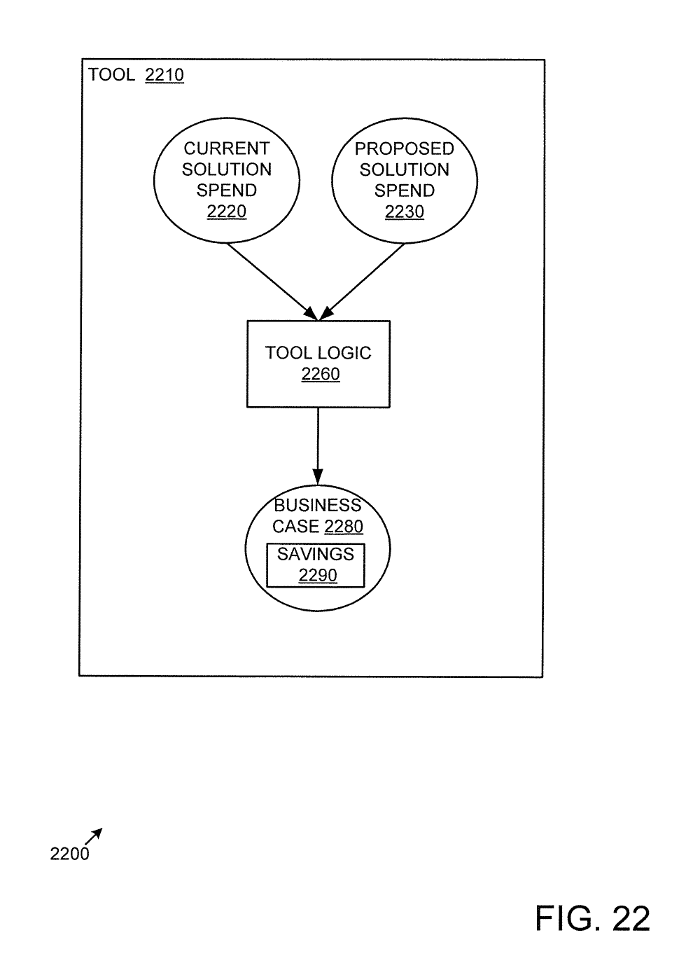

FIG. 22 is a block diagram of an exemplary system 2200 determining a business case. Inputs to the tool logic 2260 of the tool 2210 can include a current solution spend 2220 and a proposed solution spend 2230.

Output can be a business case 2280, which includes an indication of savings 2290.

### Example 42

### Exemplary Method of Determining Business Case

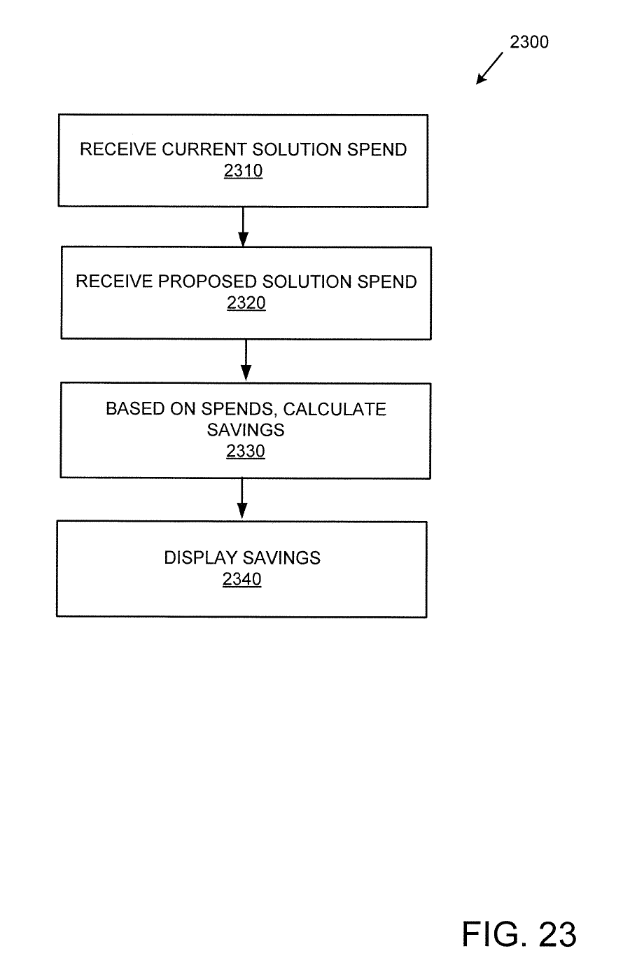

FIG. 23 is a flowchart of an exemplary method 2300 of determining a business case and can be implemented, for example by the system of FIG. 22.

At 2310, a current solution spend is received. In a tool as described herein, the current solution spend can be determined based on a variety of inputs (e.g., current number of employees in various categories, etc.).

At 2320, a proposed solution spend is received. As described herein, the proposed solution spend can be based on a variety of inputs.

Solution spends can be separately adjusted by cost of living adjustments (COLAs). Such COLAs can take the form of a time series.

At 2330, based on the spends, a savings is calculated. As described herein, the savings can be calculated as a time series over the life (e.g., contract term) of the proposed solution. Savings can be shown by bundle, by tower, and the like.

At 2340, the savings can be displayed as part of a business case. The business case can also reflect the underlying assumptions (e.g., spends) supporting the savings. The business case can be displayed on a single page for consideration by the solution architect.

### Example 43

### Exemplary System Displaying Cumulative Savings Graph

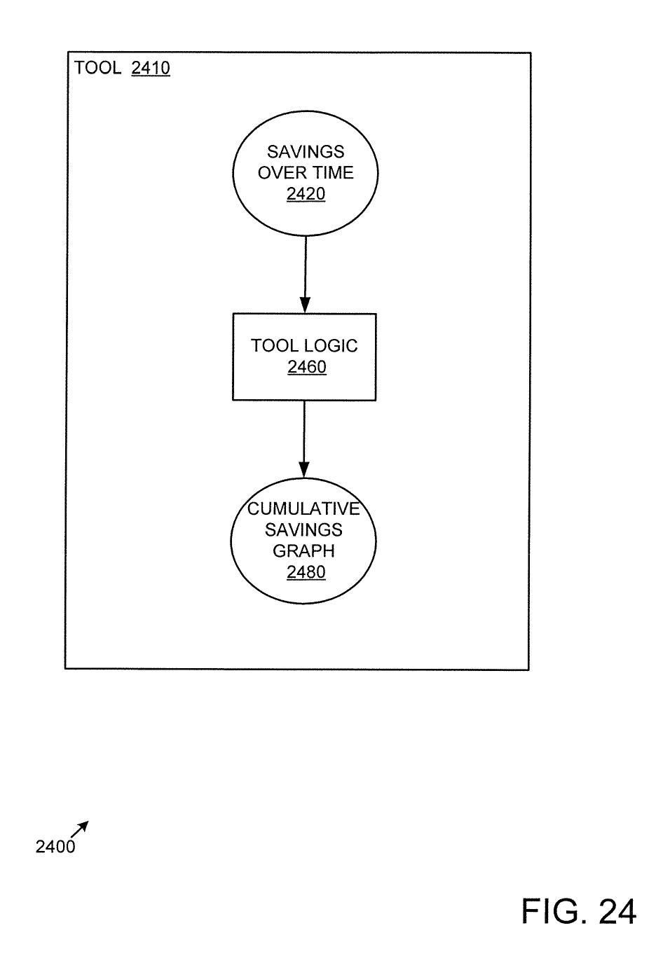

FIG. 24 is a block diagram of an exemplary system 2400 displaying a cumulative savings graph. Inputs to the tool logic 2460 of the tool 2410 can include savings over time (e.g., a time series of savings). The savings can come from the business case calculations described herein.

Output can be the cumulative savings graph 2480.

### Example 44

### Exemplary User Interface Displaying Cumulative Savings Graph

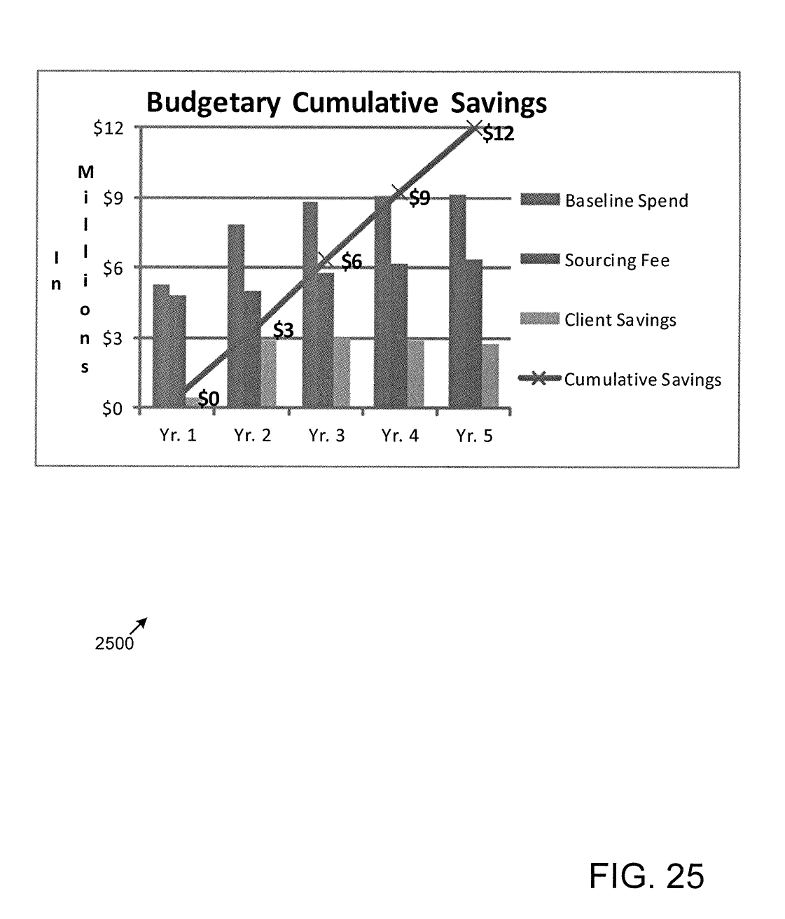

FIG. 25 is a screen shot of an exemplary user interface 2500 for displaying a cumulative savings graph and can be implemented, for example, in a system such as that shown in FIG. 24.

In the example, a bar graph shows bars for baseline spend (e.g., current solution spend), sourcing fee (e.g., proposed solution spend), and client savings (e.g., current solution spend−proposed solution spend) over time.

Also shown, is a line indicating cumulative savings (e.g., the sum of savings from the beginning of the proposal to a current time period for progressive time periods).

### Example 45

### Exemplary Method of Displaying Cumulative Savings Graph

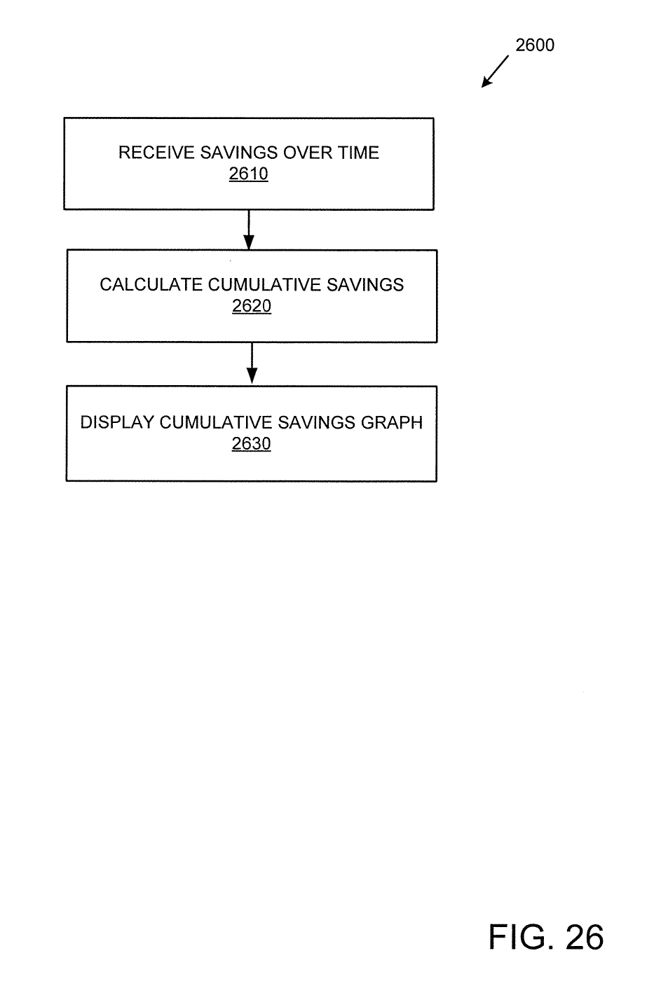

FIG. 26 is a flowchart of an exemplary method 2600 of displaying a cumulative savings graph, for example via the user interface of FIG. 25.

At 2610, savings over time (e.g., a time series of savings indicating savings per period over time) is received. As described herein, business case calculations can be used to determine savings per period.

At 2620, cumulative savings are calculated based on the savings over time.

At 2630, the cumulative savings graph is displayed and indicates the cumulative savings.

### Example 46

### Exemplary Page Organization

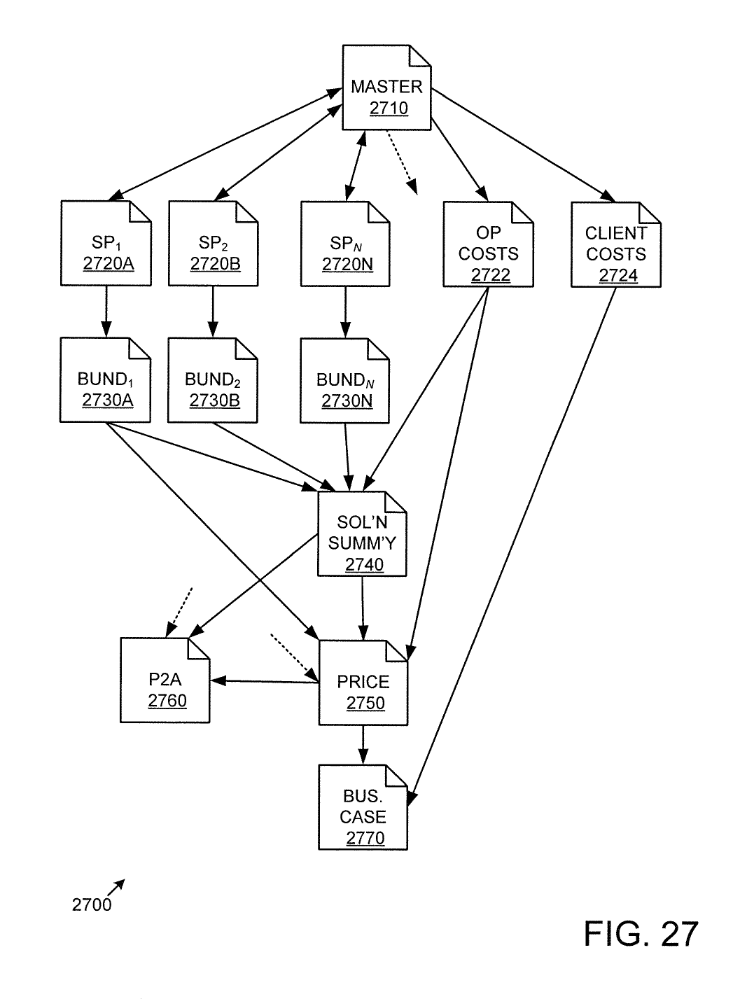

FIG. 27 is a block diagram of an exemplary page arrangement 2700 and can be used in any of the examples herein. For example, a tool employing the technologies described herein can take advantage of the page arrangement 2700.

In the example, a master page 2710 can be used to enter basic information about a proposed solution (e.g., the name of the client, the contract term, number of current employees, bundle names, tower names, which bundles are in which towers, and the like). Information can then flow from the master page 2710 to various of the other pages without having to re-enter or re-engineer the solution.

All connections between pages are not necessarily shown, however the overall flow of information can take place as shown.

Various solution parameters pages 2720A-N can be included for respective bundles. Bundle-specific information details can be input to the pages.

In addition, there can be a page for other provider costs 2722 and client costs 2724.

Various bundle pages 2730A-N can be included for respective bundles and show the results of calculations and show time series for projected costs.

A solution summary page 2740 can accumulate information from the various bundle pages 2730A-N and other provider costs 2722 to indicate a summary of the proposed solution (e.g., number of full time employees in a time series, towerwise full time employees in a time series, onsite-offshore ratios, productivity, and the like).

A price page 2750 can accumulate information from the bundle pages 2730A-N, the solution summary 2740, and other provider costs 2722 to show a price, including blended hourly rates in a time series, towerwise price in a time series, and the like.

A business case page 2770 can accumulate information from the price page 2750 and client costs page 2724 to show the business case for the proposed solution.

A price to advance page 2760 can show a comparison between the provider and competitors as described herein

A cumulative savings graph can also be presented as a page if desired. The numbers on which the cumulative savings graph can be drawn from the business case page 2770 and modified as appropriate to reflect more accurate savings.

### Example 47

### Exemplary Description

The tool can function as an integrated staffing and pricing estimation tool designed to support both reactive pursuits (RFP, RFI and RFS) and proactive pursuits during different phases of the sales cycle for IT services and BPO-services-related opportunities. The tool can support modeling solutions for multiple service towers and multiple bundled support services for a deal of multiple years. The tool output includes a comprehensive month-on-month staffing plan for each service line based on key inputs, price summary for each service line, client business case and business value including a cumulative savings. Competitor analysis is included with price-to-advance features.

### Example 48

### Exemplary Advantages

The tool can enable the deal team to meet client submission timelines for RFP, RFI, and RFS by increasing their productivity via time savings. Increased productivity of Solution Architects via time savings in crafting estimates on pricing, business cases and competitor analysis.

The tool can enable consistent output and accuracy via a pre-established format.

The tool can enable flexibility provided to individual user to input unique client information to customize it to their specific pursuit.

The scope of the tool includes addressing reactive and proactive pursuits.

The tool supports rapid modeling of “What If” scenarios to address increased competition and achievement of an optimal solution.

Scalability of the tool with ability to address multiple IT and BPO service lines simultaneously.

Transparency can be provided to allow users to view calculations behind the numbers.

### Example 49

### Exemplary Process

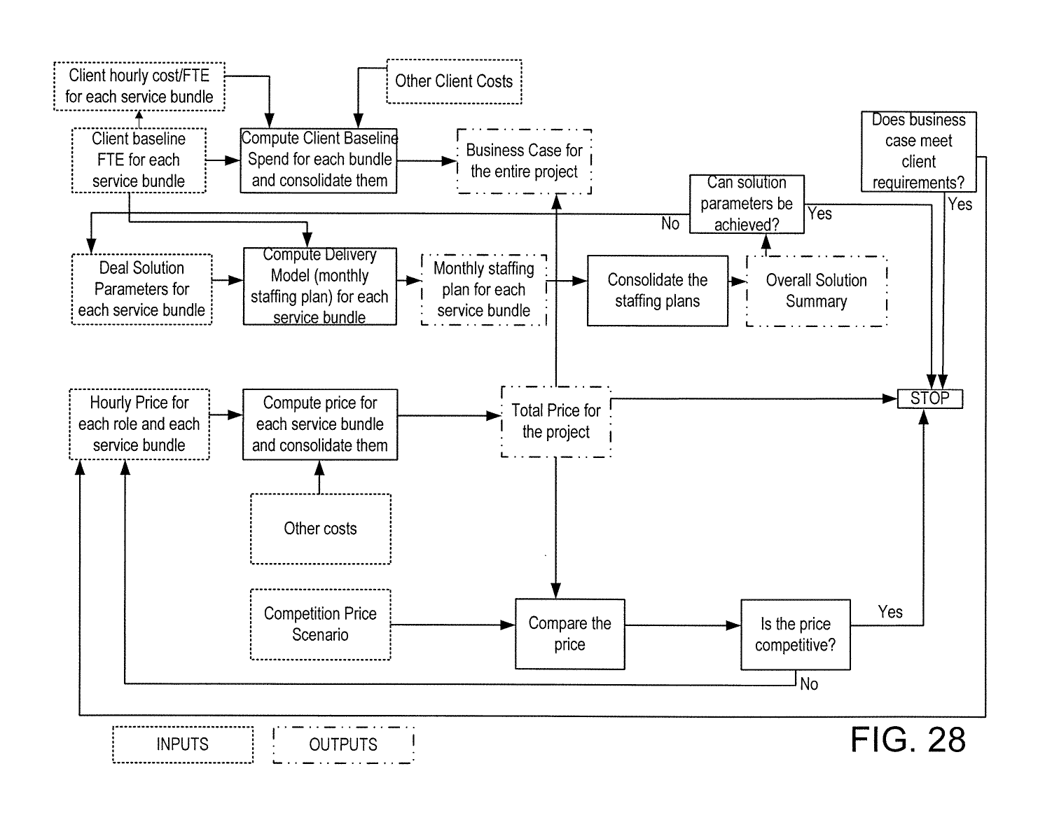

FIG. 28 is a flowchart of an exemplary process for using a strategic deal estimation tool (e.g., any of the tools described herein).

The tool can be designed for strategic deal pursuit teams to create delivery team staffing, client pricing and business case savings using a top-down approach for estimates with limited inputs. Inputs include: service bundles to be provided, existing client IT staff by role, current cost estimates, solution parameters and external hourly price by role.

Service bundles are the services in scope for the strategic deal. Some examples are application development, maintenance, testing, business process services, infrastructure management services etc. Client baseline staffing is input based on full time equivalents with a distinction of how many are on-site versus off-shore along with whether they are in-house resources or are vendor resources leveraged by the client. Hourly cost estimates of the client's staffing multiplied by the quantity of resources establishes the client base-line costs upon which the provider solution will be compared against to ultimately determine potential client savings.

Solution parameters reference aspects of the solution in delivering the service to the client including: onsite/offshore ratio of staffing, periodic productivity improvements, delivery team roles and role ratios. Additionally, external hourly pricing for each role and service bundle is applied against the specific quantities and locations of the Infosys delivery resources throughout the term of the engagement to determine applicable pricing. There is a provision to adjust this price for cost of living adjustment (COLA).

Multiple service bundles can be consolidated into common groupings also called towers. The towers can be multiple geographies for a deal or different client divisions for which the services are being provided Infrastructure Management Services and Business process services like finance and accounting, human resource management are also addressed by SDET.

For each service bundle, a monthly staffing by role is computed. A Solution Summary output section provides a consolidated view of solution parameters for the proposed solution. Pricing details are computed for each service bundle and tower. The business case comprises the deal price less the client baseline cost and identifies the client savings potential.

The strategic deal pursuit team member using SDET reviews the output to evaluate whether the solution parameters can be achieved from both a service delivery and competitive perspective. If the answer is no, then onsite/off-shore ratios, productivity improvements and role ratios are re-evaluated and adjusted accordingly; otherwise this aspect is resolved.

The price is also reviewed to ensure it is competitive. If it is not, then the hourly rates, roles and role ratios are evaluated and adjusted accordingly to increase the odds of winning a pursuit, while staying within corporate guidelines from a risk perspective; otherwise this aspect is resolved.

The business case provides a summary of the client baseline costs less deal pricing by tower, service bundle, year and grand total with applicable savings in terms of dollars and percentages for the applicable timeframe.

### Example 50

### Exemplary Dependencies

In examples herein, where calculations are described as “based on” certain parameters, such calculations can further be based on additional parameters other than those described.

### Example 51

### Exemplary Additional Details for Implementation

The various features herein can be incorporated into a tool for use in Microsoft® Excel® spreadsheet software. User instructions, frequently asked questions, and examples can be integrated into the tool to provide user training and navigation

Various conventions can be used to make the tool easier to use. For example, green can be used to denote input (e.g., input sheets, input cells, or the like). Blue can be used to denote output.

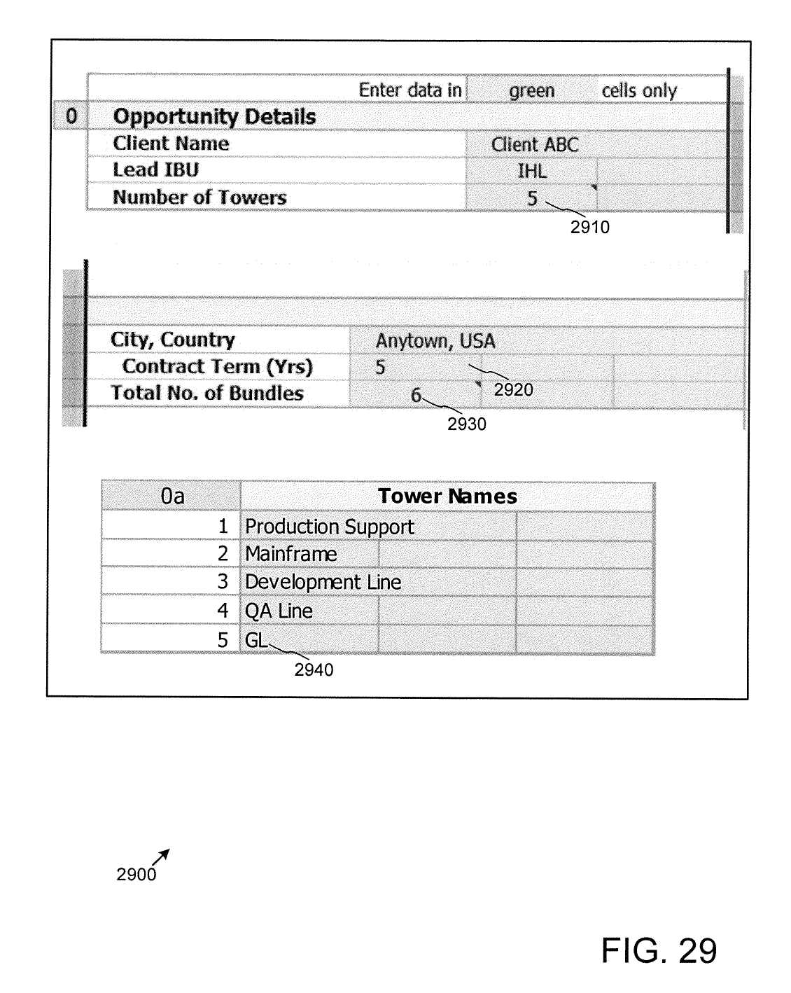

FIG. 29 is a screen shot of an exemplary user interface 2900 for a master page. In the example, there are two tables: 0 and 0a.

Table 0 can be used to input the client name, number of towers 2910, contract term in years 2920, and number of bundles 2930.

Table 0a can be used to enter the tower names 2940.

The received input can be propagated from the mater sheet to other sheets, saving duplication of effort by the solution architect.

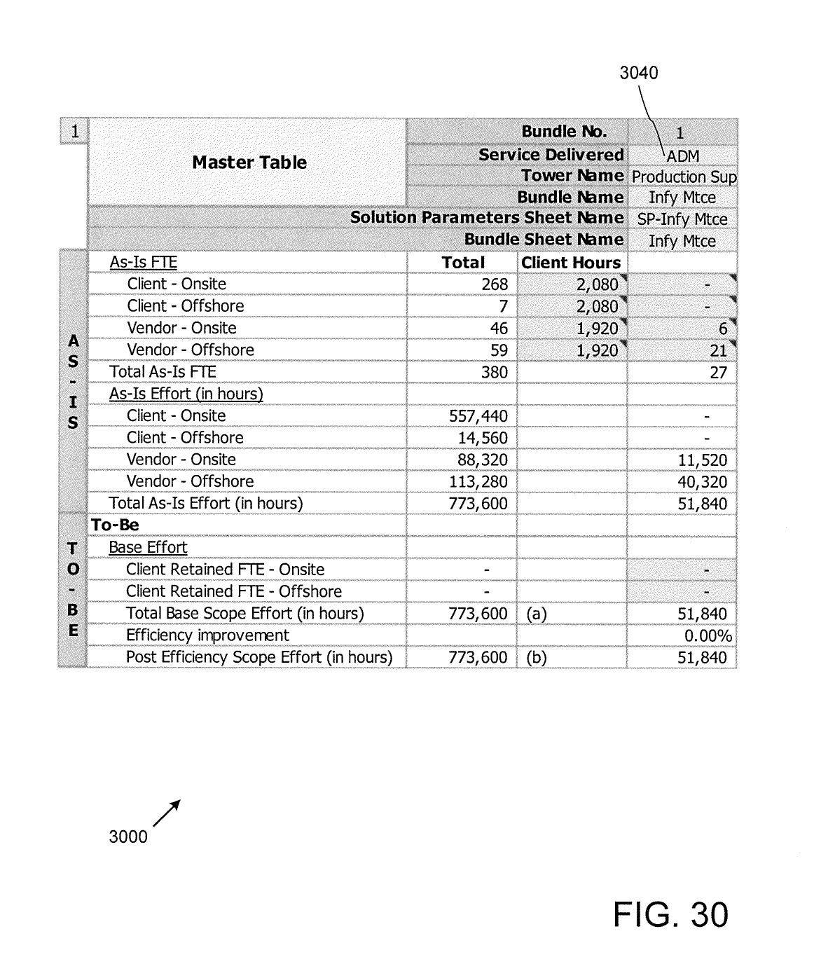

FIG. 30 is a screen shot of another exemplary user interface 3000 for a master page. In the example, a dropdown menu appears when the cell 3040 is selected by which a user can select a technology process outsourcing service type. Although only one column for one service type is shown, additional columns can support additional (e.g., different) service types or instances of the same service type.

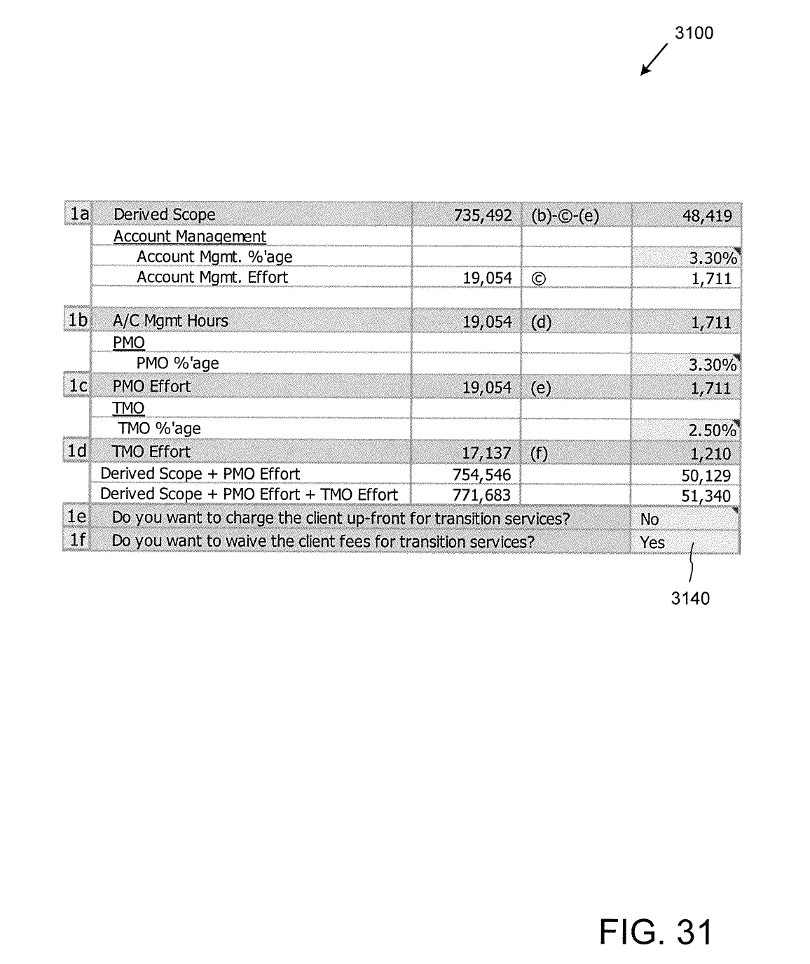

FIG. 31 is screen shot of another exemplary user interface 3100 for a master page. In the example, transition scenarios can be selected by a dropdown menu that appears when the cell 3140 is selected.

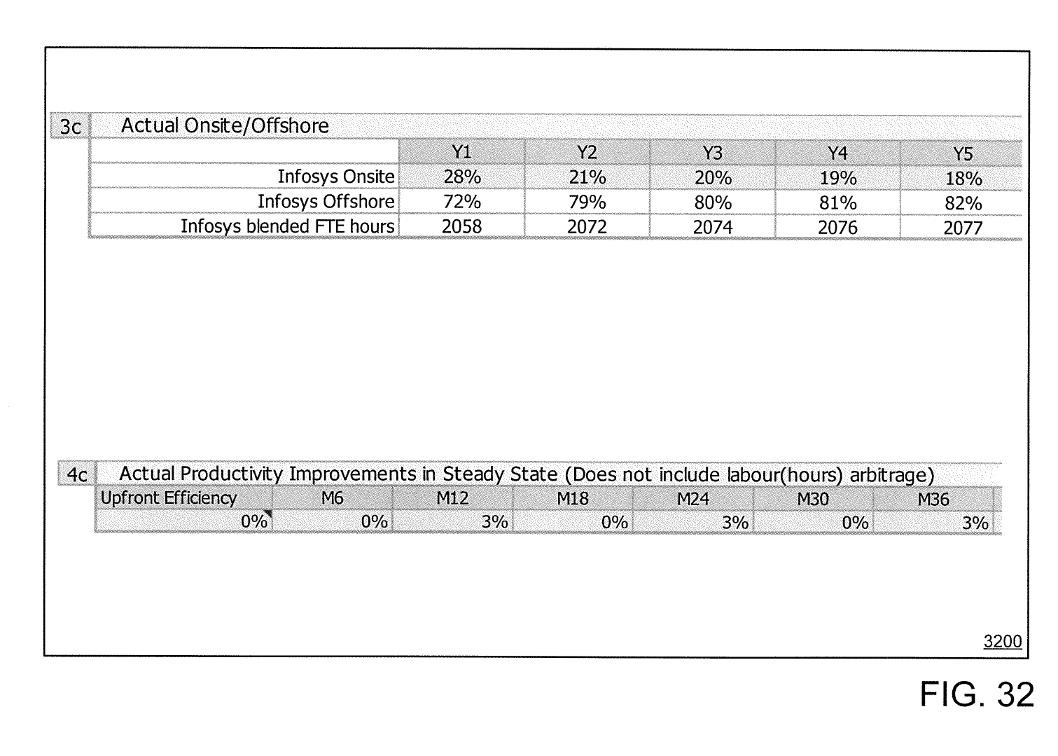

FIG. 32 is screen shot of an exemplary user interface 3200 for a solution parameters page (e.g., specific to a particular bundle). In the example, default parameters for onsite/offshore ratios and productivity improvements are shown. Such default parameters can be selected responsive to having selected a service type via the user interface of FIG. 30 in accordance with the method of FIG. 8. Transition scenarios can be selected by a dropdown menu (e.g., with “yes” and “no”) that appears when the cell 3140 is selected.

### Example 52

### Exemplary Additional Details for Implementation

A possible organization of sheets for the spreadsheet implementation for a provider

“Infosys Limited” is as follows:

### Master Sheet

The master sheet is the first input sheet and has a green tab. Please find below the description of each table.

Table 0: Opportunity Details: In this table information that is to be inserted is the Client name, location, Lead IBU, Contract Terms in Years, and Number of towers and Bundles.
Table 0a: This is the table to insert Tower Names.
Table 1: This table takes multiple inputs.
Service Delivery: The dropdown menu selection of ADM, IMS and BPO for that specific bundle.
Solution Parameter Sheet Names: This is an input cell. A User will create the Solution parameters sheets based on the names specified in this cell. (Example F12)
AS-IS: In this section, input—Client and Vendors onsite and offshore work hours and also the number of FTEs per bundle
TO-BE: Post outsourcing the client retained FTE onsite and offshore details are inserted in this section
   Table 1a: This table gives the output as a Derived scope. Derived scope is the final effort number in hours when account overheads and efficiency improvements are removed.
   Table 1b: Recommended Account Management Percentage is given. Users have an option to override the recommended numbers. Note: The initial (AS IS FTE) quantity for Clients is assumed to include the function of Account Management. The recommended %'s for Provider Solution is based on Client Size of FTEs and can be adjusted up or down as needed in working with the IBU and Engagement Teams when building the solution for the pursuit. A different recommended % is calculated when BPO is the solution choice.
   Table 1c: Recommended PMO Percentage is specified. Users have an option to override the recommended numbers. document.
   Table 1d: Recommended TMO Percentage is specified. Users have an option to override the recommended numbers.
   Table 1e: This table gives flexibility to calculate the Transition cost. It has the flexibility to charge transition upfront to the client or over contract term.
   Table 1f: This option allows users to charge the client or waive the transition services.

### SP-<Bundle Name> (Solutions Parameters)

Solution parameter sheets are input sheets (green); the list of table and input parameter descriptions follows.

Table 0: Most of the inputs to this table are directly coming from Master sheet, like Tower name, Tower Service, Bundle Name and Contract Term (Yrs). The user only has to choose IBU/HBU from a dropdown menu.
Table 1: Reserved for future functionality.
Table 2 (2a, 2b, 2c): Working hours for Provider, Client and vendors. These details are directly taken from Master Sheet.
Table 3: Onsite/Offshore Ratio: This table has 3 different sub-tables. 3a is for Recommended Onsite Offshore ratio which takes inputs from Table 1. Table 3b has recommended onsite-offshore ratio as per Infosys Delivery Risk management group (DRMG). In Table 3c, the recommended numbers can be consulted, and changes can be made in final onsite offshore ratio based on the solution architect's experience. Default parameters can be placed here based on selection of service type instead of being based on inputs to table 1.
Table 4: Productivity Improvement: As described above, this table has sub-tables 4a for recommended numbers based on your inputs in table 1, 4b productivity threshold numbers from Infosys Delivery Risk Management Group (DRMG) and table 4c where user has the flexibility to alter the final number. Default parameters can be used based on service type selected for the bundle instead of being based on inputs to table 1.
Table 5: Role ratio, Rate Card and COLA: Here 5a table is hidden which has the most commonly used roles for that specific IBU/HBU. 5b has the details about recommended Role %, Role Ratio, recommended numbers from Table 1 and DRMG. The last table 5c is where user has an opportunity to insert the numbers based on experience.
Table 6: Transition: Table 6a: here insert the details like from which month the transition is starting and what is the duration of transition in weeks, Table 6b is for the calculation of Transition Staff on Board. This will give the details as to how the ramp up of the resources would happen. In table 6c ramp-up of transition staff Onsite is calculated.
Table 7: In this table recommended numbers for Account Management, PMO and TMO are given for small, medium and large accounts.

If Service Delivered is selected as IMS or BPO from Master Sheet, then following table are grayed out: Table 1, 3 and 5 (and default solution parameters are used).

### Other Provider Costs

Other Provider Costs is again an input sheet and has 10 tables which are described below:
Table 0: AS-IS Client FTE: This table does not require inputs from user, but take inputs from Master Sheet. It has the details about AS-IS Client and Vendor FTE bundle-wise and tower-wise.
Table 1: Travel Related Costs (in MUSD): These details are calculated both Bundle and Towerwise for international and domestic travels. Users have a flexibility to choose if this Travel Costs is client billable or not.
Table 2: Communication Costs (in MUSD): Again Bundle and Towerwise calculations where users insert Cost Per Person Per month and No. of FTEs. Users have a flexibility to choose if this Communication Costs is Client billable or not.
Table 3: Asset Take Over Costs (in MUSD): Here user has an option to insert following details: Purchase amount, Term or number of years, profit % and Maintenance %. Users have a flexibility to choose if this Asset Take Over Costs is Client billable or not.
Table 4: Non-Standard Hardware and Software (in MUSD): Here user has an option to insert following details: Purchase amount, Term or number of years, Profit % and Maintenance %. Users have a flexibility to choose if this Non-Standard Hardware and Software Costs is Client billable or not.
Table 5: Software Development (in MUSD): Here user has an option to insert following details: Number of FTE, Term/Yrs., Hourly Cost. Users have a flexibility to choose if this Cost is Client billable or not.
Table 6: Rebadge Costs: This table offers high-level Rebadge Cost. This also helps us calculate tower and bundle wise details. Input from the user is as follows: # FETs, average Annual salary, Profit percentage and Bridge %. Users have a flexibility to choose if this Cost is Client billable or not.
Table 7: Open For Input (in MUSD): The tool offers flexibility to add deal specific parameters as Other Infosys Cost calculations. Like Non-Labor Costs including but not limited to the following examples: Training costs, Portals, Network costs (one time and recurring), ODC setup cost, etc.

### Table 8, 9: Same as Table 7.

### Client Costs

Table 0: AS-IS Client FTE's Computation: This table does not require inputs from user, but take inputs from Master Sheet. It has the details about AS-IS Client and Vendor FTE bundle-wise and tower-wise.
Table 1: AS-IS Total Client Spend Bundle-wise (in MUSD) Computation: User has an option to insert following rates: Client onsite and Offshore, Vendor onsite and offshore.
Table 2: Business Case Input (Other Client To-Be Costs) (in MUSD): This table has 8 subsections, which takes inputs as client TO-BE costs for Business case.
Table 2a: Client Severance Costs (in MUSD): This table calculates Client to-be severance cost. User inserts following inputs: Onsite Hourly Cost, Onsite FTEs Redeployed, Offshore Hourly Costs, Offshore FTEs Redeployed and number of Months for Severance. Severance costs can be computed by multiplying the number of severed employees, the monthly severance amount, and how many months of severance will be paid. Severance calculations can be done separately for onsite and offshore employees, and the hourly rate can be different for each. Total severance is calculated by adding severance costs for onsite employees and severance costs for offshore employees.
Table 2b: Client Governance Cost (in MUSD): This table calculates likely Client Governance Cost. User inserts following details: Number of FTEs, Hourly Cost and Number of Hours. Client governance costs can be calculated by multiplying number of FTEs, hourly cost, and number of hours.
Table 2c: Client Deal Consultant Costs (in MUSD): This table calculates likely Client Deal Consultant Costs. User inserts following details: Number of FTEs, Hourly Cost and Number of Hours. Client deal consultant costs can be calculated by multiplying number of FTEs, hourly cost, and number of hours.
Table 2d: Client Lawyer/Legal Costs (in MUSD): This table calculates likely Client Lawyer/Legal Costs. User inserts following details: Number of FTEs, Hourly Cost and Number of Hours. Client legal costs can be calculated by multiplying number of FTEs, hourly cost, and number of hours.
Table 2e: Part (A) Client Retained FTE's during transition (in MUSD): This table calculates the likely cost of Client Retained FTE's during Transition. The input is Transition in months, Number of FTEs retained during transition and Hourly Cost/Person.
Table 2f: Part (B) Client Retained FTE's “Post” transition (in MUSD): This table calculates the likely cost of Client Retained FTEs post Transition. The input is Number of Months Required to retain the FTEs, number of retained during transition, Hourly Cost/Person and Percentage SMEs needed in post transition scenario.
Table 2g: Open for Input (in MUSD): The tool offers flexibility to add deal specific parameters as a to-be Client Cost.
Table 2h: Open for Input (in MUSD): The tool offers flexibility to add deal specific parameters as a to-be Client Cost.
Table 2i: Open for Input (in MUSD): The tool offers flexibility to add deal specific parameters as a to-be Client Cost

### Individual Bundle Solutions Sheets

This is an output only sheet and so has been colored Blue. Please find below main tables this sheet has and output which it generates.
Table 0: Price Summary in MUSD: This table in an output table which gives Pricing Summary per year for the contract duration. For first year it provides transition and Steady state details.
Table 1: Control Table A—Transition Schedule: The inputs are taken from Master sheet and from respective Solution Parameter Sheets. It has the details like Transition Start Month, Transition duration, Steady State Start.
Table 1A: Resource Plan Sheet Control: This table gives the reference to cell in Master sheet from where all the important parameters are picked up.
Table 2: Control Table B—Transition Parameters: This table gives the output as onsite and offshore % and number of FTE required during transition.
Table 3: Control Table C—Steady State Parameters: This table gives Steady State parameters like Productivity Improvement, Derived Scope, onsite offshore percentage for steady state and number of FTEs for that specific bundle.
Table 4: Control Table D—Governance Parameters: This table gives the staffing details for AMO, PMO and TMO for specific Bundle.
Table 5: Bundle Staffing Plan: This table summarizes month-wise staffing plan for that specific Bundle
Table 5a: Onsite Transition FTE: Month-wise staffing for onsite Transition FTEs for different roles defined in Solution Parameter sheet.
Table 5b: Onsite Steady State FTE: Month-wise staffing for onsite Steady State FTEs for different roles defined in Solution Parameter sheet.
Table 5c: Offshore Transition FTE: Month-wise staffing for Offshore Transition FTEs for different roles defined in Solution Parameter sheet.
Table 5d: Offshore Steady State FTE: Month-wise staffing for Offshore Steady State FTEs for different roles defined in Solution Parameter sheet.
Table 5e: A/C Mgmt FTE: Month-wise staffing for Onsite and Offshore Steady State FTEs for different roles defined in Solution Parameter sheet.
Table 5f: PMO FTE: Month-wise staffing for Onsite and Offshore Steady State FTEs for different roles defined in Solution Parameter sheet.
Table 5g: TMO FTE: Month-wise staffing for Onsite and Offshore Steady State FTEs for different roles defined in Solution Parameter sheet.

### Solutions Summary

This is an output only sheet and so has been colored Blue. This sheet has Solutions Summary for a deal. Please find below main tables this sheet has and output which it generates.
Table 1: FTE (first month of each contract year): This table generates FTEs summary per year for a pursuit. The output has a breakup of the towers and bundles. This has many sub-tables which gives onsite and offshore FTE too.
Table 2: Effort Summary (in million hours): This table generates Effort summary per year for a pursuit. The output has a breakup of the towers and bundles. This has many sub-tables which gives onsite and offshore steady state and transition effort.
Table 3: Onsite-Offshore Ratio: This table will generate onsite-offshore ratio for both steady state and transition.
Table 4: Productivity: This table generates different productivity numbers. Year 1 Productivity based number of Steady State months delivered in Y1 compared to the base effort for those months. Year 2 Productivity is based on an assumption we deliver full 12 months, using the average monthly effort for Y1. Following are the formulas which have been used.
Year-on-Year Productivity (Effort based)=(Last Year Effort−This Year Effort)/(Last Year Effort)
Cumulative Annual Productivity (Effort based)=(Base Year Effort−This Year Effort)/(Base Year Effort)
Year-on-Year Productivity (FTE based)=(Last Year FTE−This Year FTE)/(Last Year FTE)
Cumulative Annual Productivity (FTE based)=(Base Year FTE−This Year FTE)/(Base Year FTE)

### Price

This is an output only sheet and so has been colored Blue. This sheet has Price Summary for a deal. Please find below main tables this sheet has and output which it generates.
Table 1: Price Summary (in MUSD): This table generates tower and bundle wise pricing summary.
Table 2: Blended hourly rate (in USD): This table generates tower and bundle wise blended hourly rates.
Table 3a: Price (On-Site Resources): This table generates tower and bundle wise Price for On-Site Resources
Table 3b: Price (Off-Shore Resources): This table generates tower and bundle wise Price for Off-Shore Resources

### Business Case P&L Summary

This is a sheet which accepts some inputs from user and so has been colored Orange.
Table 1: AS-IS Total Client Spend Bundle wise (in MUSD): In this table user has the flexibility to change the yearly client cost and the COLA numbers.
Table 2A: Infosys Price Summary (in MUSD): This table generates Infosys Price for a deal
Table 2B: Other To-Be Client Costs (in MUSD): In this table a user can insert year-wise Other To-Be client costs.
Table 2C: Total To-Be Costs (in MUSD): This is total of Infosys Price and other to-be cost.
Table 3A: Savings (in MUSD: This is AS-IS Total Client spending minus Total To-Be costs.
Table 3B: Savings % (in MUSD): This table generates tower-wise total saving % for the client.

### Business Case Cash-Flow Summary

This is an output table and so has been colored Blue.
Table 1: AS-IS Total Client Spend Bundle wise (in MUSD): This table generates AS-IS Total Client Spend Bundle and Towerwise
Table 2A: Infosys Price Summary (in MUSD): This table generates Infosys Price for a deal
Table 2B: Other To-Be Client Costs (in MUSD): This table is generated from similar table from Business case P&L summary sheet.
Table 2C: Total To-Be Costs (in MUSD): This table is generated from similar table from Business case P&L summary sheet.
Table 3: Net Cash-flow (in MUSD): This table generates Net-Cash Flow post outsourcing

### P2A

This is a Price to Advance sheet.

Input can be placed in the green shaded cells.

Multiple factors are involved in client evaluation, and this is only focused on the price aspect, which is typically the key determinant.

Input of current PAT % in cell comes from the DPS PAT %, while desired PAT % can be any figure you choose in order to perform “What If” analysis on the impact on price. The desired PAT % should be at or above the minimum allowed.

Input of a desired PAT % in cell will illustrate the impact on the blended rate in terms of rate, change from current rate as a % and as an amount in cells.

Total Savings and % of savings from Client Estimated Baseline is illustrated in cells is highlighted in yellow.

### Example 53

### Exemplary Computing Environment

The techniques and solutions described herein can be performed by software, hardware, or both of a computing environment, such as one or more computing devices. For example, computing devices include server computers, desktop computers, laptop computers, notebook computers, handheld devices, netbooks, tablet devices, mobile devices, PDAs, and other types of computing devices.

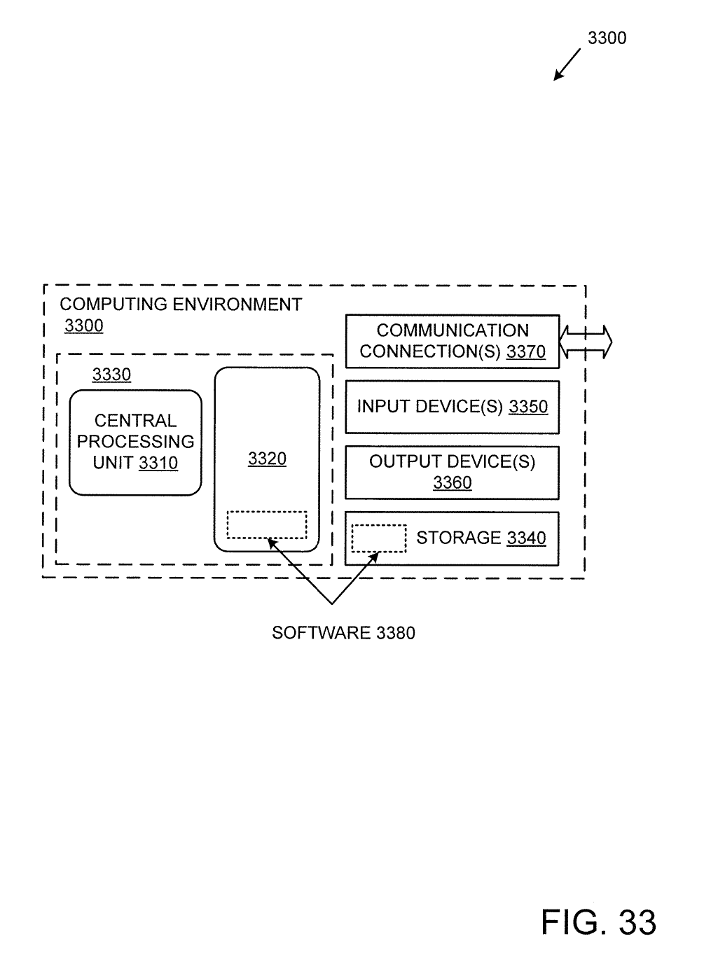

FIG. 33 illustrates a generalized example of a suitable computing environment 3300 in which the described technologies can be implemented. The computing environment 3300 is not intended to suggest any limitation as to scope of use or functionality, as the technologies may be implemented in diverse general-purpose or special-purpose computing environments. For example, the disclosed technology may be implemented using a computing device comprising a processing unit, memory, and storage storing computer-executable instructions implementing the enterprise computing platform technologies described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like. The disclosed technology may also be practiced in distributed computing environments where tasks are performed by remote processing devices that are linked through a communications network. In a distributed computing environment, program modules may be located in both local and remote memory storage devices

With reference to FIG. 33, the computing environment 3300 includes at least one processing unit 3310 coupled to memory 3320. In FIG. 33, this basic configuration 3330 is included within a dashed line. The processing unit 3310 executes computer-executable instructions and may be a real or a virtual processor. In a multi-processing system, multiple processing units execute computer-executable instructions to increase processing power. The memory 3320 may be volatile memory (e.g., registers, cache, RAM), non-volatile memory (e.g., ROM, EEPROM, flash memory, etc.), or some combination of the two. The memory 3320 can store software 3380 implementing any of the technologies described herein.

A computing environment may have additional features. For example, the computing environment 3300 includes storage 3340, one or more input devices 3350, one or more output devices 3360, and one or more communication connections 3370. An interconnection mechanism (not shown) such as a bus, controller, or network interconnects the components of the computing environment 3300. Typically, operating system software (not shown) provides an operating environment for other software executing in the computing environment 3300, and coordinates activities of the components of the computing environment 3300.

The storage 3340 may be removable or non-removable, and includes magnetic disks, magnetic tapes or cassettes, CD-ROMs, CD-RWs, DVDs, or any other computer-readable media which can be used to store information and which can be accessed within the computing environment 3300. The storage 3340 can store software 3380 containing instructions for any of the technologies described herein.

The input device(s) 3350 may be a touch input device such as a keyboard, mouse, pen, or trackball, a voice input device, a scanning device, or another device that provides input to the computing environment 3300. For audio, the input device(s) 3350 may be a sound card or similar device that accepts audio input in analog or digital form, or a CD-ROM reader that provides audio samples to the computing environment. The output device(s) 3360 may be a display, printer, speaker, CD-writer, or another device that provides output from the computing environment 3300.

The communication connection(s) 3370 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, magnetic storage, optical storage, or the like). Such instructions can cause a computer to perform the method.

### ALTERNATIVES

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. One or more computer-readable storage devices comprising computer-executable instructions causing a computer to perform a method comprising:
receiving an indication of current staffing resources for a current information technology services solution;
receiving an indication of a technology process outsourcing service type for a proposed information technology services solution to replace the current information technology services solution;
responsive to the indication of the technology process outsourcing service type, selecting default solution parameters associated with the technology process outsourcing service type; and
based on the indication of current staffing resources and the default solution parameters, calculating a business case for replacing the current information technology services solution with the proposed information technology services solution, wherein calculating the business case comprises calculating an estimated savings if the proposed information technology services solution were to be implemented to replace the current information technology services solution.

2. The one or more computer-readable storage devices of claim 1 wherein:
the default parameters comprise a time series indicating an offshore ratio increasing over time during the life of the proposed information technology services solution.

3. The one or more computer-readable storage devices of claim 1 wherein the method further comprises:
receiving a plurality of technology process outsourcing service types for a plurality of service bundles associated with the proposed information technology services solution; and
responsive to the indications, selecting different default solution parameters for respective of the service bundles.

4. The one or more computer-readable storage devices of claim 3 wherein:
the service bundles are associated with respective organizational towers; and
the business case indicates savings by the organizational towers on a towerwise basis.

5. The one or more computer-readable storage devices of claim 1 wherein:
the indication of a technology process outsourcing service type is received via a dropdown menu listing possible technology process outsourcing service types.

6. The one or more computer-readable storage devices of claim 1 wherein:
calculating an estimated savings if the proposed information technology services solution were to be implemented comprises:
calculating a current solution spend;
calculating a proposed solution spend; and
calculating a difference between the current solution spend and the proposed solution spend.

7. The one or more computer-readable storage devices of claim 7 wherein the method further comprises:
receiving a client cost of a client cost type; and
choosing between allocating the client cost to the current solution spend or the proposed solution spend according to the client cost type.

8. The one or more computer-readable storage devices of claim 7 wherein the method further comprises:
receiving input parameters for a client cost; and
determining how to calculate the client cost from the input parameters based on the client cost type.

9. The one or more computer-readable storage devices of claim 6 wherein the method further comprises:
storing a provider cost;
receiving an indication of whether the provider cost is billable; and
responsive to the indication, selectively including the provider cost in the proposed solution spend.

10. The one or more computer-readable storage devices of claim 9 wherein the method further comprises:
receiving a plurality of provider costs;
receiving a plurality of indications of whether the provider costs are billable; and
responsive to the indications, selectively including the provider costs in the proposed solution spend, wherein the provider costs include costs for travel related costs, communication costs, asset takeover costs, non-standard hardware and software costs, software development costs, and rebadge costs.

11. The one or more computer-readable storage devices of claim 1 wherein the method further comprises:
receiving an indication of an incumbent vendor;
calculating grand total solution prices for a provider vendor and a one or more competitor vendors, wherein the calculating adjusts transition costs for the incumbent vendor; and
comparing the provider grand total solution price to the one or more competitor grand total solution prices.

12. The one or more computer-readable storage devices of claim 1 wherein the method further comprises:
receiving an indication of a particular transition scenario; and
responsive to the indication of the particular transition scenario, re-calculating the business case.

13. The one or more computer-readable storage devices of claim 1 wherein the method further comprises:
receiving onsite-onshore percentages indicating a distribution of employees between onsite status and offshore status;
receiving labor roles; and
receiving labor rates for respective of the labor roles; and
based on the onsite-onshore percentages, the labor roles, and the labor rates, calculating a blended hourly rate; and
displaying the blended hourly rate.

14. The one or more computer-readable storage devices of claim 6 wherein the method further comprises:
calculating a current solution spend for respective organizational towers;
calculating a proposed solution spend for respective organizational towers;
calculating a difference between the current solution spend and the proposed solution spend for respective organizational towers; and
displaying the difference for the respective organizational towers.

15. The one or more computer-readable storage devices of claim 1 wherein:
calculating the estimated savings comprises calculating a time series indicating savings per period over time;
calculating cumulative savings based on the time series; and
displaying a cumulative savings graph indicating the cumulative savings.

16. The one or more computer-readable storage devices of claim 1 wherein:
solution parameters are organized as displayed on per-bundle solution parameter pages.

17. The one or more computer-readable storage devices of claim 1 wherein:
a master page displays and accepts input of a name of a client, a term of a contract, and current staffing resources.

18. The one or more computer-readable storage devices of claim 1 wherein:
a business case page stores a name of a client, a term of a contract, and current staffing resources.

19. A method implemented at least in part by one or more computing devices, the method comprising:
receiving solution parameters for a proposed information technology services solution;
receiving an indication of whether transition costs for the proposed information technology services solution are to be charged up front;
receiving an indication of whether the transition costs for the proposed information technology services solution are to be waived;
responsive to determining that the transition costs are not to be waived and that the transition costs are not to be charged up front, spreading the transition costs out over a term of the proposed information technology services solution; and
displaying a business case showing savings over time if the proposed information technology services solution were to be adopted, wherein the savings reflect having spread the transition costs over the term of the proposed information technology services solution.

20. A computer system comprising:
a processor; and
memory storing computer-executable instructions causing the computer system to:
receiving bundle names for a plurality of service bundles representing services included in a proposed information technology services solution for a client;
receiving organizational tower names for a plurality of organizational towers representing organizational units of the client;
receiving indications of associations between the service bundles and the organizational towers;
receiving a plurality of solution parameters for respective of the service bundles indicating various aspects of a proposed information technology services solution;
receiving an indication of a technology process outsourcing service type for the proposed information technology services solution;
responsive to the indication of the service type, selecting default solution parameters; and
calculating an estimated savings if the proposed information technology services solution were to be implemented.
